(19) United States
(12) Patent Application Publication
(10) Pub. No.: US 2010/0142545 A1
(43) Pub. Date: Jun. 10, 2010

(54) NETWORK APPARATUS, EDGE ROUTER, AND PACKET COMMUNICATION SYSTEM

(75) Inventor: Toshihiko KURITA, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/609,342

(22) Filed: Oct. 30, 2009

(30) Foreign Application Priority Data
Dec. 9, 2008 (JP) 2008-313745

(51) Int. Cl. H04L 12/56

(52) U.S. Cl. 370/401

(57) ABSTRACT

A network apparatus includes: a slot table for storing a record including an identifier of a time slot witch is assigned to packet transmission from a particular transmission source to a particular transmission destination, and respective identifiers of an input interface and an output interface which are used for the packet transmission; and means for, upon receiving a first control packet which includes an identifier of a particular time slot and indicates a start of the particular time slot, specifying the input interface and the output interface corresponding to the particular time slot from the slot table, and for sending out one or more packets from the specified input interface to the specified output interface during a period until receiving a second control packet which includes the identifier of the particular time slot and indicates an end of the particular time slot.

### CROSS-REFERENCE TO RELATED APPLICATION

This application is based upon and claims the benefit of priority from the prior Japanese Patent Application No. 2008-313745 filed on Dec. 9, 2008, the entire contents of which are incorporated herein by reference.

### BACKGROUND

1. Field

The embodiments discussed herein are related to a communication control technique, and more particularly to a technique for saving power consumed by a network apparatus.

2. Description of Related Art

Recently, the volume of traffic transferred through an information communication network has increased to a large extent, and power consumed by the entire network has also increased correspondingly. In particular, power consumption of a router has increased significantly. In the router, a packet buffering process and a routing table search process occupy 30% or more of the entire power consumption.

Hitherto, TDM (Time Division Multiplexing), MPLS (Multi-Protocol Label Switching), etc. are known as techniques for improving the utilization efficiency of a network. In TDM, for example, data can be multiplexed on the time base and data traffic can be transferred in a bufferless manner. Regarding control traffic to determine routes, however, each router is required to execute a buffering process and a routing process. Accordingly, power saving in the entire router is not so expected. In MPLS, because a packet is transferred by using a label that has been defined between routers, a load of the routing process can be reduced. However, a packet collision cannot be avoided and the buffering process is required. For that reason, power saving in the router is not so expected as well.

### SUMMARY

According to an embodiment, a network apparatus includes: a slot table for storing a record including an identifier of a time slot witch is assigned to packet transmission from a particular transmission source to a particular transmission destination, and respective identifiers of an input interface and an output interface which are used for the packet transmission; and means for, upon receiving a first control packet which includes an identifier of a particular time slot and indicates a start of the particular time slot, specifying the input interface and the output interface corresponding to the particular time slot from the slot table, and for sending out one or more packets from the specified input interface to the specified output interface during a period until receiving a second control packet which includes the identifier of the particular time slot and indicates an end of the particular time slot.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an outline of a packet communication system;

FIG. 2 illustrates a frame and a time slot;

FIG. 3 illustrates a control packet;

FIG. 4 illustrates the operating principle of the packet communication system;

FIG. 5 illustrates an outline of the packet communication system;

FIG. 6 illustrates an outline of the packet communication system;

FIG. 7 illustrates an outline of the packet communication system;

FIG. 8 is a block diagram of an edge router in a first embodiment;

FIG. 9 is a block diagram of a relay router in the first embodiment;

FIG. 10 is a block diagram of a management server in the first embodiment;

FIG. 11 illustrates an example of an edge router table;

FIG. 12 illustrates an example of a path management table;

FIG. 13 illustrates an example of a slot reservation table;

FIG. 14 illustrates an example of a slot table;

FIG. 15 illustrates an example of a route ID table;

FIG. 16 illustrates an example of a route/link management table;

FIG. 17 illustrates an example of a slot assignment table;

FIG. 18 illustrates an example of a link use situation table;

FIG. 19 is a flowchart of processing executed in the entire system when a time slot is reserved in the first embodiment;

FIG. 20 illustrates packets sent out in time slots;

FIG. 21 is a flowchart of processing executed in the entire system when a time slot is released in the first embodiment;

FIG. 22 illustrates a packet sent out in the time slot;

FIG. 23 is a flowchart of processing executed at startup of the management server;

FIG. 24 illustrates a guard time;

FIG. 25 illustrates examples of calculation of a slot time;

FIG. 26 is a flowchart of processing executed in the management server when a time slot is reserved;

FIG. 27 is a flowchart of a slot reservation process;

FIG. 28 is a flowchart of processing executed in the management server when a time slot is released;

FIG. 29 is a flowchart of a slot release process;

FIG. 30 is a flowchart of processing executed in the edge router when a time slot is assigned;

FIG. 31 is a flowchart (first part) of processing executed in the edge router when a time slot is switched over in the first embodiment;

FIG. 32 is a flowchart (second part) of processing executed in the edge router when a time slot is switched over in the first embodiment;

FIG. 33 is a flowchart of processing executed in the edge router upon time-out of a timer;

FIG. 34 is a flowchart (first part) of processing executed in the relay router;

FIG. 35 is a flowchart (second part) of processing executed in the relay router;

FIG. 36 is a block diagram of a management server in a second embodiment;

FIG. 37 illustrates an example of a slot reservation table;

FIG. 38 is a flowchart of processing executed in the entire system when a time slot is reserved in the second embodiment;

FIG. 39 illustrates a packet sent out in the time slot;

FIG. 40 is a flowchart of processing executed in the entire system when a time slot is released in the second embodiment;

FIG. 41 is a flowchart of a slot reservation message transmitting process;

FIG. 42 is a flowchart of a slot release message transmitting process;

FIG. 43 is a flowchart of a slot reservation message receiving process;

FIG. 44 is a flowchart of a slot release message receiving process;

FIG. 45 is a flowchart of processing executed in the edge router when a time slot is switched over in the second embodiment;

FIG. 46 is a flowchart of processing executed in the relay router when a slot reservation message is received;

FIG. 47 is a flowchart of processing executed in the relay router when a slot release message is received;

FIG. 48 is a block diagram of a management server in a third embodiment;

FIG. 49 illustrates an example of a collision management table;

FIG. 50 illustrates checks necessary for generating the collision management table;

FIG. 51 is a flowchart of processing executed when the collision management table is executed;

FIG. 52 is a flowchart of a slot reservation process 2;

FIG. 53 is a flowchart of a slot release process 2; and

FIG. 54 is a block diagram of a computer.

### DETAILED DESCRIPTION OF EXAMPLE EMBODIMENTS

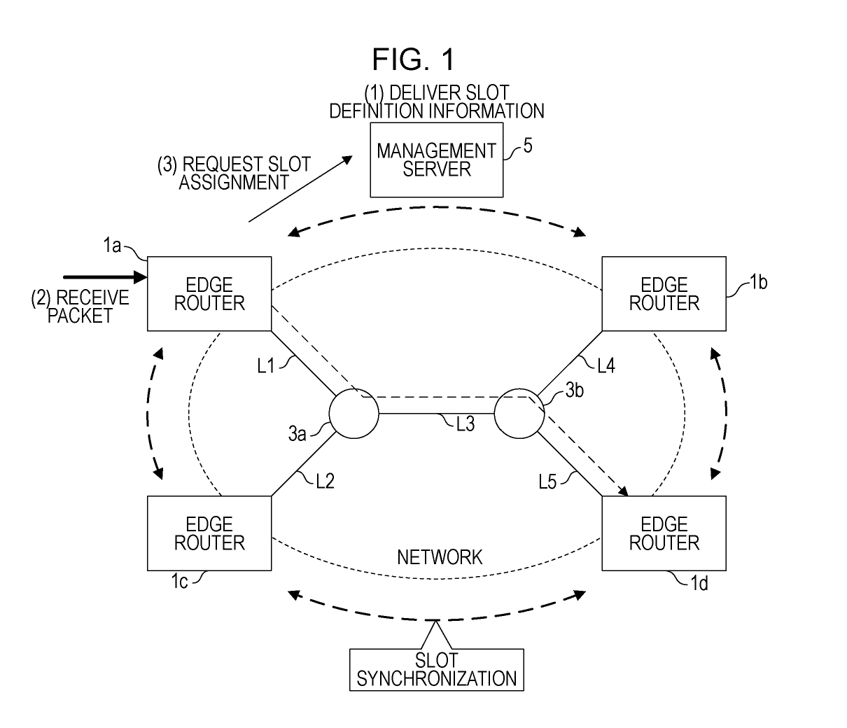

First, an outline of a packet communication system according to an embodiment of the present technique will be described below with reference to FIGS. 1 to 7. As illustrated in FIG. 1, the packet communication system according to the embodiment of the present technique includes, for example, edge routers 1 (specifically 1a to 1d in FIG. 1), relay routers 3 (specifically 3a and 3b in FIG. 1), and a management server 5. The edge routers 1 are each connected to an external network (not shown). Also, in FIG. 1, the relay router 3a is connected to the edge router 1a via a link L1, to the edge router 1c via a link L2, and to the relay router 3b via a link L3, respectively. Further, the relay router 3b is connected to the edge router 1b via a link L4 and to the edge router 1d via a link L5. While four edge routers 1 and two relay routers 3 are illustrated in FIG. 1, the number of the edge routers 1 and the number of the relay routers 3 are not limited to the illustrated ones. The embodiment of the present technique is premised on the following points. Transfer rates in the links L1 to L5 are assumed to be all equal to one another. A propagation delay between the edge routers 1 is assumed to be about several hundreds milliseconds at maximum. In addition, it is assumed that the management server 5 can confirm the configuration of the network by employing such a protocol as SNMP (Simple Network Management Protocol), for example.

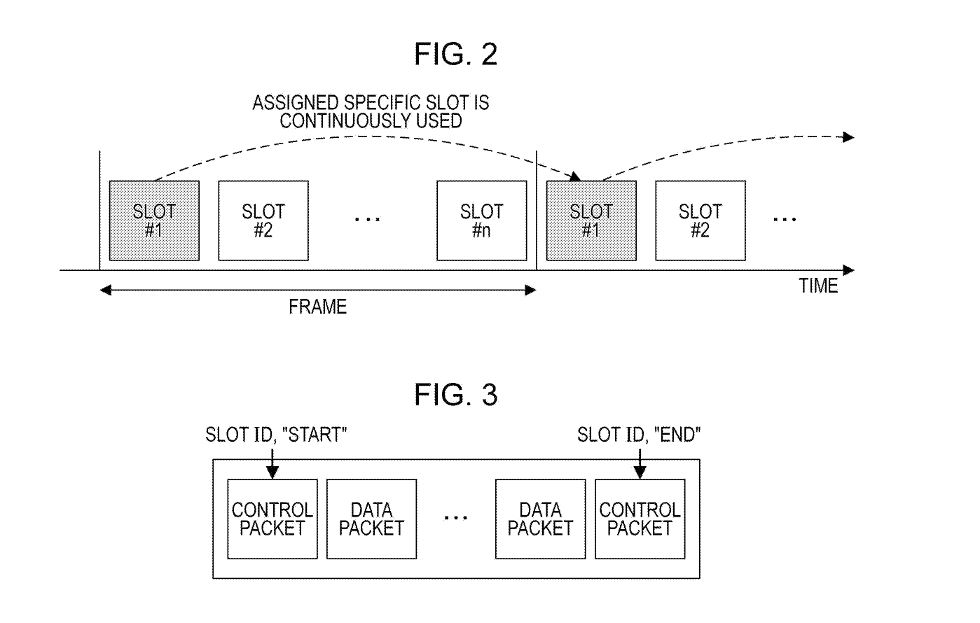

The operating principle of the packet communication system will be described below with reference to FIGS. 2 to 4. As illustrated in FIG. 2, for example, one frame includes a number n of time slots (i.e., a slot #1, a slot #2, . . . , and a slot #n). Be it noted that the term “time slot” is also simply called a “slot” hereinafter. For example, the slot #1 is assigned to some packet communication such that the relevant packet communication is performed by using the slot #1 in each frame. In that case, other packet communications are not performed by using the slot #1, whereby a packet collision does not occur between and the relevant packet and the other packets. Further, a control packet illustrated in FIG. 3 is transferred in order to notify the relay router 3 of the respective timings of start and end of the slot #1. A communication route of the packet communication performed by using the slot #1 is held fixed. This implies that data packets are just required to be continuously transferred to an output interface corresponding to the relevant communication route and a routing process is not required to be performed per data packet. Thus, in the packet communication system according to the embodiment, a time slot causing no packet collision with other packets is assigned to some packet communication, and the relevant packet communication is performed by using the assigned time slot.

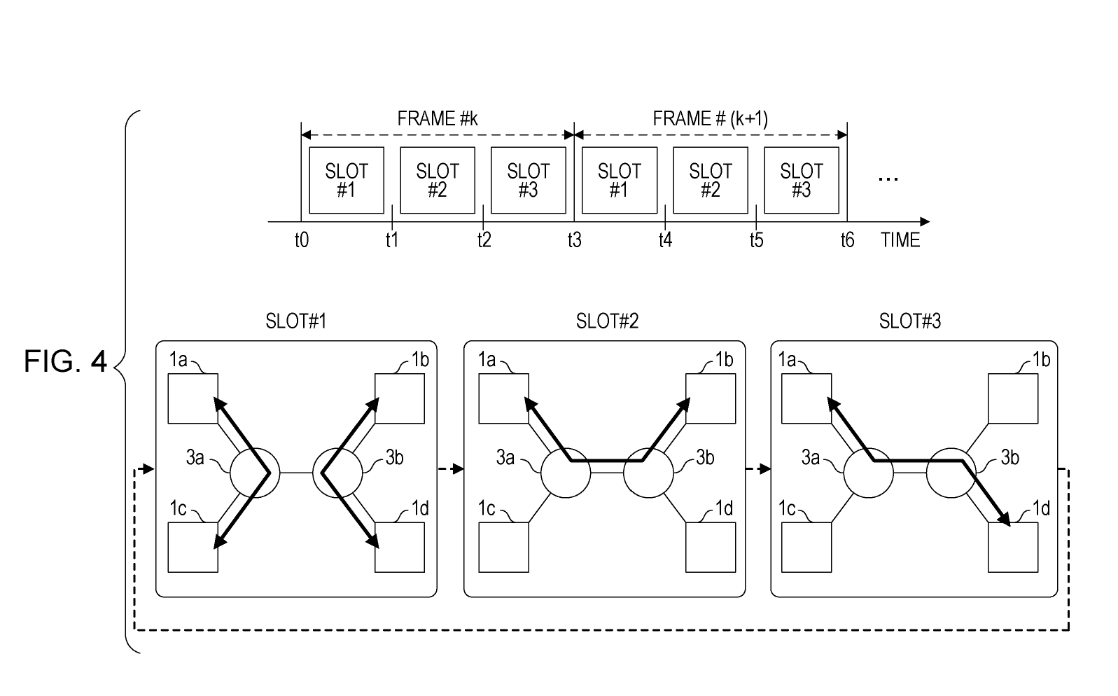

FIG. 4 illustrates an example in which the number of time slots included in one frame is three. Referring to FIG. 4, the slot #1 (t0 to t1, t3 to t4, etc. on the time base of FIG. 4) is used to perform packet communication between the edge router 1a and the edge router 1c and to perform packet communication between the edge router 1b and the edge router 1d. Also, the slot #2 (t1 to t2, t4 to t5, etc. on the time base of FIG. 4) is used to perform packet communication between the edge router 1a and the edge router 1b. Further, the slot #3 (t2 to t3, t5 to t6, etc. on the time base of FIG. 4) is used to perform packet communication between the edge router 1a and the edge router 1d. The example of FIG. 4 is premised on the case where other packet communications (e.g., packet communication between the edge router 1c and the edge router 1d) than the illustrated packet communications are not performed. If the other one or more packet communications are performed, four or more slots are prepared in advance.

An outline of processing executed in the packet communication system, illustrated in FIG. 1, will be described below. After startup, the management server 5 first delivers slot definition information to each edge router 1 (FIG. 1: step (1)). The slot definition information includes the number of time slots (also simply called “slots” hereinafter) contained in one frame, a transmission time (described later), etc. Further, the management server 5 periodically delivers sync time information to each edge router 1. Each edge router 1 synchronizes time slots in accordance with the slot definition information and the sync time information.

Then, for example, the edge router 1a receives at least one packet from the external network (step (2)) and stores the received packet in a queue. It is here assumed that the edge router 1a receives at least one packet which is to be sent out to the external network through the edge router 1d. The edge router 1a determines whether the time slot for transmitting the relevant packet is already assigned. If the time slot is not yet assigned, the edge router 1a transmits a slot assignment request to the management server 5 (step (3)). The slot assignment request includes an identifier of the edge router at a transmission source (called the source-edge router) and an identifier of the edge router at a transmission destination (called the destination-edge router).

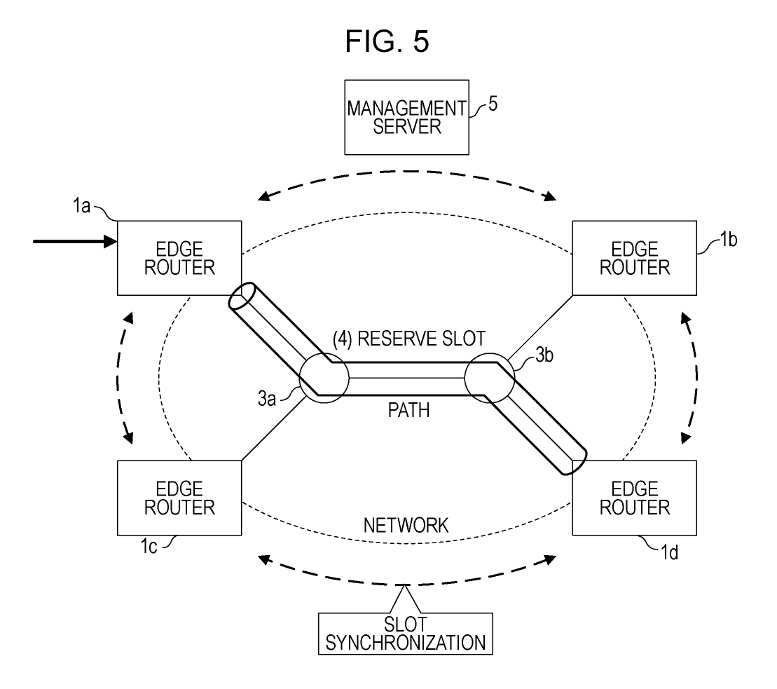

Turning now to FIG. 5, in response to the slot assignment request, the management server 5 assigns a time slot that will not cause any packet collisions. It is here assumed that a slot #i is assigned. Then, the edge router 1a, the relay router 3a, the relay router 3b, and the edge router 1d execute a process for reserving the slot #i (FIG. 5: step (4)). The time slot assigning process and the time slot reserving process will be described in detail later.

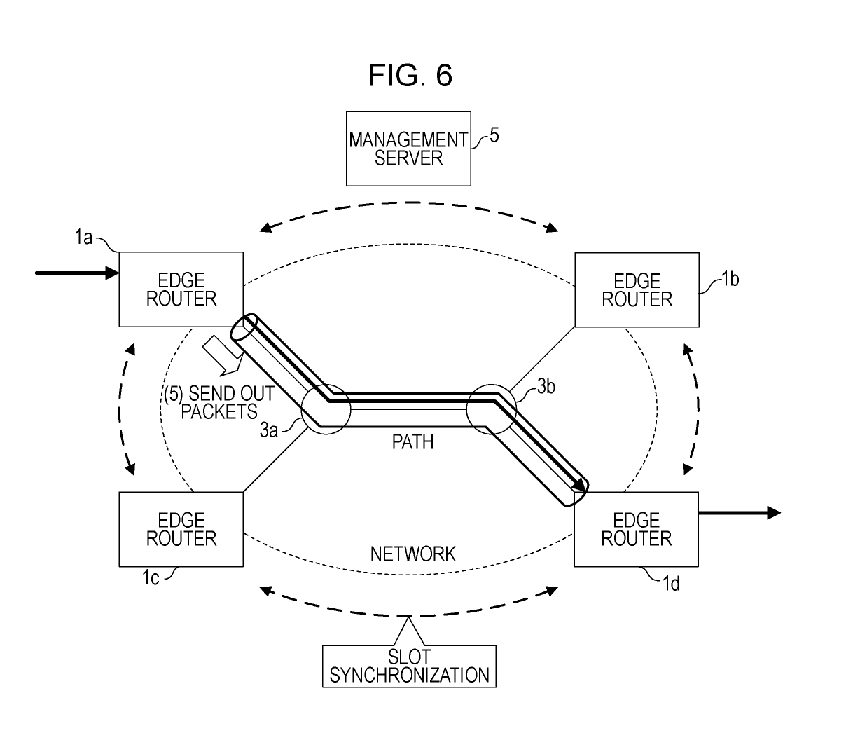

Turning now to FIG. 6, upon detecting the switching-over to the slot #i, the edge router 1a sends out a control packet including the ID of the time slot and the control type “start”. After sending the control packet, the edge router 1a reads the packet (also called the “data packet” hereinafter) from the queue and sends out the packet (step (5)). Further, the edge router 1a sends out, as a final packet in the relevant time slot, a control packet including the ID of the time slot and the control type “end”.

The edge router 1d receives the control packets and the data packet from the edge router 1a via the relay router 3a and the relay router 3b, and sends out the received data packet to the external network that is the transmission destination.

The edge router 1a repeats the above-described step (5) in the slot #i in each of the subsequent frames.

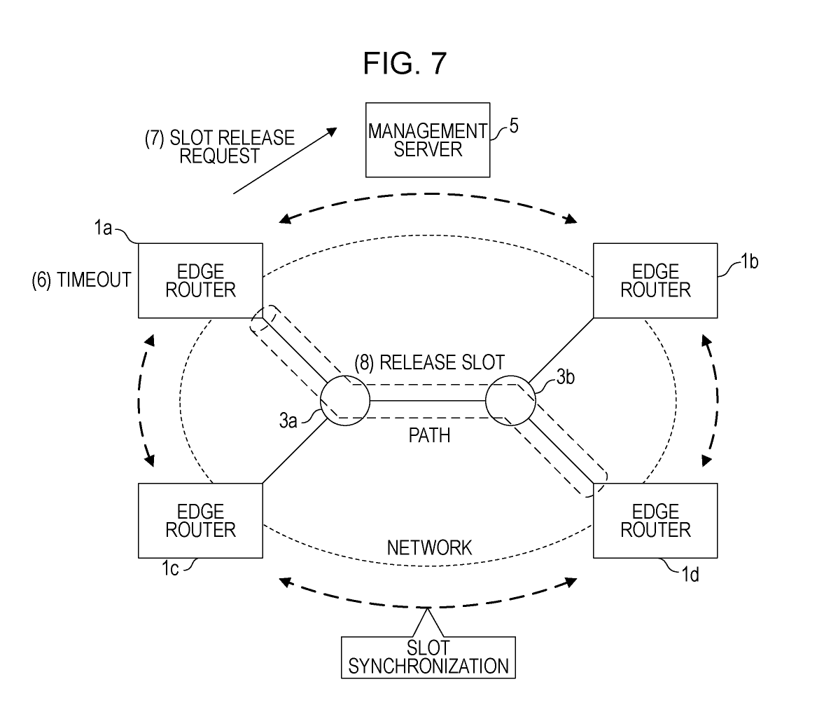

Turning now to FIG. 7, after storing one packet in the queue, for example, the edge router 1a starts a timer. If the edge router 1a receives a next packet until the end of a certain time, it restarts the timer. In other words, if the next packet is not received until the end of the certain time, the edge router 1a detects a timeout of the timer (FIG. 7: step (6)). Then, the edge router 1a transmits a slot release request to the management server 5 (step (7)). The slot release request includes the identifier of the source-edge router and the identifier of the destination-edge router.

In response to the slot release request, the management server 5 specifies the time slot which is to be released. It is here assumed that a slot #j is specified as a time slot to be released. Further, the management server 5, the edge router 1a, the relay router 3a, the relay router 3b, and the edge router 1d execute a process of releasing the slot #j (step (8)). The time slot release process will be described in detail later.

### First Embodiment

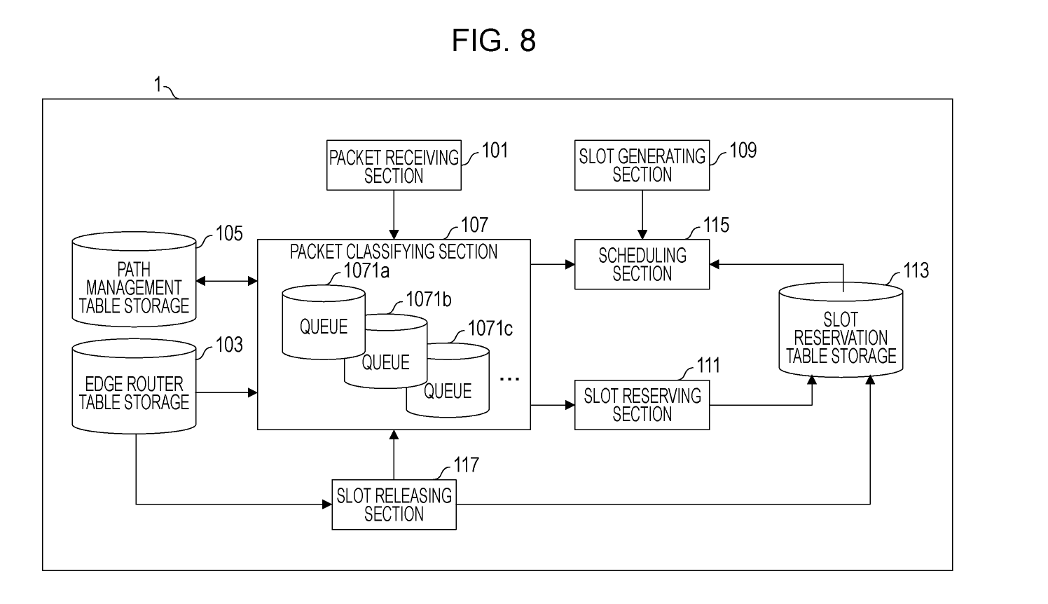

A first embodiment of the present technique will be described below with reference to FIGS. 8 to 35. A packet communication system according to the first embodiment includes, as illustrated in FIG. 1, the edge routers 1, the relay routers 3, and the management server 5.

FIG. 8 is a functional block diagram of the edge router 1 in the first embodiment. The edge router 1 in the first embodiment includes a packet receiving section 101, an edge router table storage 103, a path management table storage 105, a packet classifying section 107, a slot generating section 109, a slot reserving section 111, a slot reservation table storage 113, a scheduling section 115, and a slot releasing section 117. The edge router table storage 103 stores an edge router table described later. The path management table storage 105 stores a path management table described later. The slot reservation table storage 113 stores a slot reservation table described later.

The packet receiving section 101 receives the packet from the external network and outputs the received packet to the packet classifying section 107. The packet classifying section 107 generates or deletes one or more queues 1071 (specifically, 1071a, 1071b, 1071c, etc. in FIG. 8) corresponding respectively to one or more destination-edge routers, as required. Also, in accordance with data stored in the edge router table storage 103 and the path management table storage 105, the packet classifying section 107 stores the packet, which has been received by the packet receiving section 101, in one of the queues 1071, or notifies the slot reserving section 111 of the necessity of assigning the time slot when the assignment of the time slot is required. The slot generating section 109 receives, from the management server 5, the slot definition information including the number of slots contained in one frame, the slot time, and the transmission time, and then outputs the received slot definition information to the scheduling section 115. The slot reserving section 111 transmits the slot assignment request to the management server 5 in response to an instruction from the packet classifying section 107. Also, when the time slot is assigned from the management server 5, the slot reserving section 111 registers the time slot in the slot reservation table which is stored in the slot reservation table storage 113. In accordance with the slot definition information received by the slot generating section 109, sync time information received from the management server 5, and with the slot reservation table stored in the slot reservation table storage 113, the scheduling section 115 executes, for example, a process of reading the data packet, which is to be sent out in the time slot at the current time, from the queue 1071 in the packet classifying section 107, and then sending out the read data packet. The slot releasing section 117 executes a process of releasing the time slot based on the data stored in both the edge router table storage 103 and the slot reservation table storage 113. Further, the slot releasing section 117 outputs, to the packet classifying section 107, an instruction indicating deletion of the queue 1071 that corresponds to the released time slot.

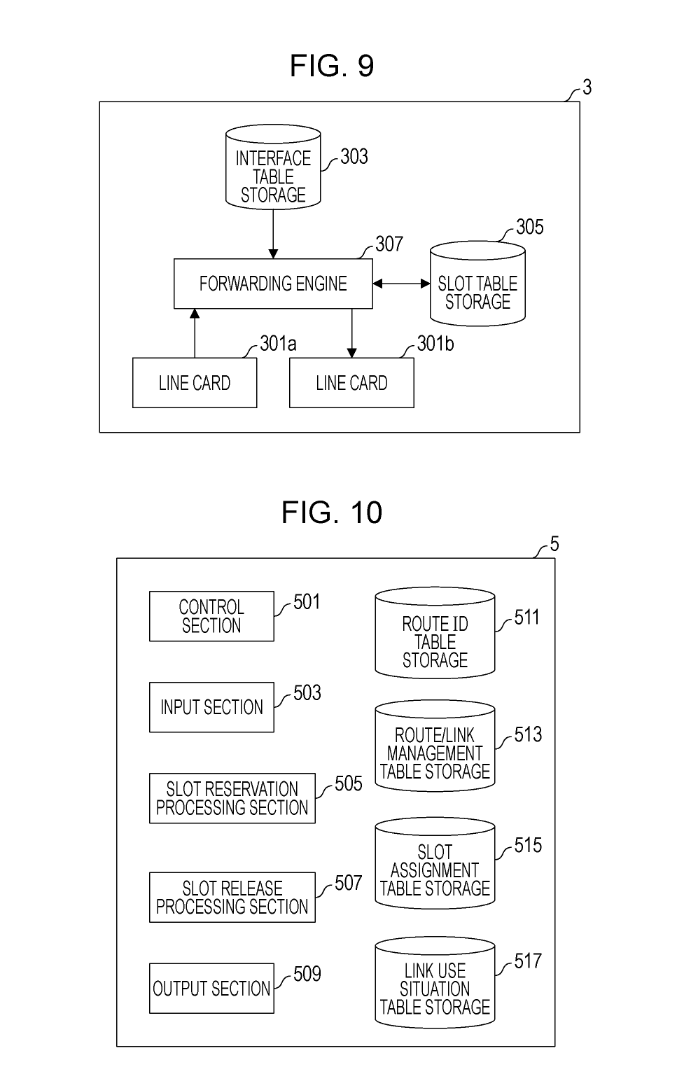

FIG. 9 is a functional block diagram of the relay router 3 in the first embodiment. The relay router 3 in the first embodiment includes a plurality of line cards 301 (specifically, 301a and 301b in FIG. 9), an interface (IF) table storage 303, a slot table storage 305, and a forwarding engine 307. The IF table storage 303 stores an IF table including information of the adjacent edge router 1 or the other one or more relay routers 3, and information of IFs connected to the relevant network apparatus. The slot table storage 305 stores a slot table described later.

The line cards 301 is connected to the edge router 1 which is positioned adjacent via the transmission path, or to the other relay router 3. The forwarding engine 307 registers a new record in the slot table storage 305 by using communication path information provided from the edge router 1 and the data stored in the IF table storage 303, and/or transfers the packet in accordance with the slot table stored in the slot table storage 305.

FIG. 10 is a functional block diagram of the management server 5 in the first embodiment. The management server 5 in the first embodiment includes a control section 501, an input section 503, a slot reservation processing section 505, a slot release processing section 507, an output section 509, a route ID table storage 511, a route/link management table storage 513, a slot assignment table storage 515, and a link use situation table storage 517. The route ID table storage 511 stores a route ID table described later. The route/link management table storage 513 stores a route/link management table described later. The slot assignment table storage 515 stores a slot assignment table described later. The link use situation table storage 517 stores a link use situation table described later.

After the startup of the management server 5, the control section 501 calculates a guard time (described later), a transmission time, and a slot time, and then transmits them to the edge router 1. The input section 503 receives the slot assignment request and the slot release request from the edge router 1, and then outputs those requests to the slot reservation processing section 505 and the slot release processing section 507, respectively. The slot reservation processing section 505 executes a slot reservation process (described later) based on data contained in the slot assignment request which has been received by the input section 503. The slot release processing section 507 executes a slot release process (described later) based on data contained in the slot release request which has been received by the input section 503. The output section 509 outputs a result of the slot reservation process executed in the slot reservation processing section 505 and a result of the slot release process executed in the slot release processing section 507.

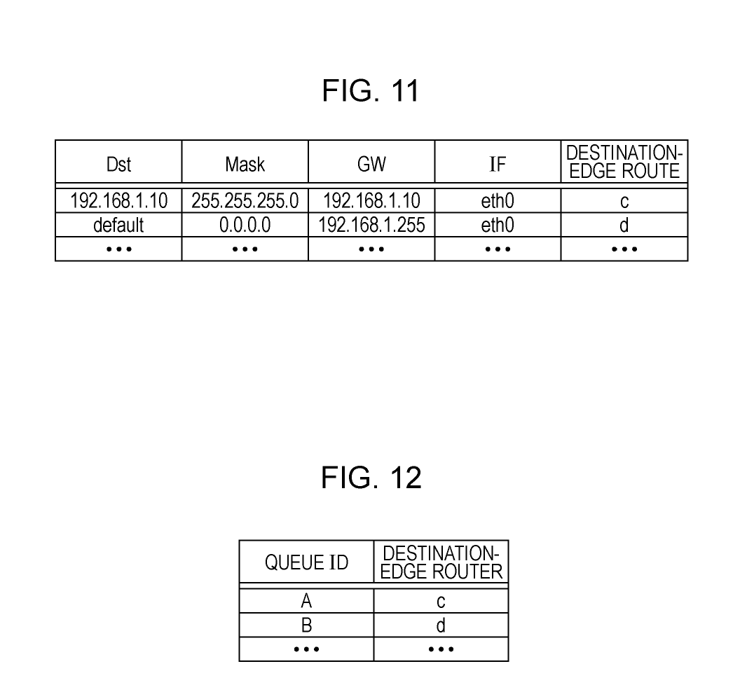

FIG. 11 illustrates an example of the edge router table stored in the edge router table storage 103. In the example of FIG. 11, the edge router table includes a column of “destination address (Dst)”, a column of “net mask (Mask)”, a column of “default gateway (GW)”, a column of “output interface (IF)”, and a column of “destination-edge router”. Be it noted that the destination address, the net mask, the default gateway, and the output interface are the same as those data stored in the known routing table. Also, an identifier of one (called the destination-edge router) among the edge routers, which outputs, to the external network, the packet transmitted in accordance with the setting of the relevant record, is previously set in the column of “destination-edge router”.

FIG. 12 illustrates an example of the path management table stored in the path management table storage 105. In the example of FIG. 12, the path management table includes a column of “queue ID” and a column of “destination-edge router”. The path management table is used to specify the queue 1071 corresponding to the destination-edge router.

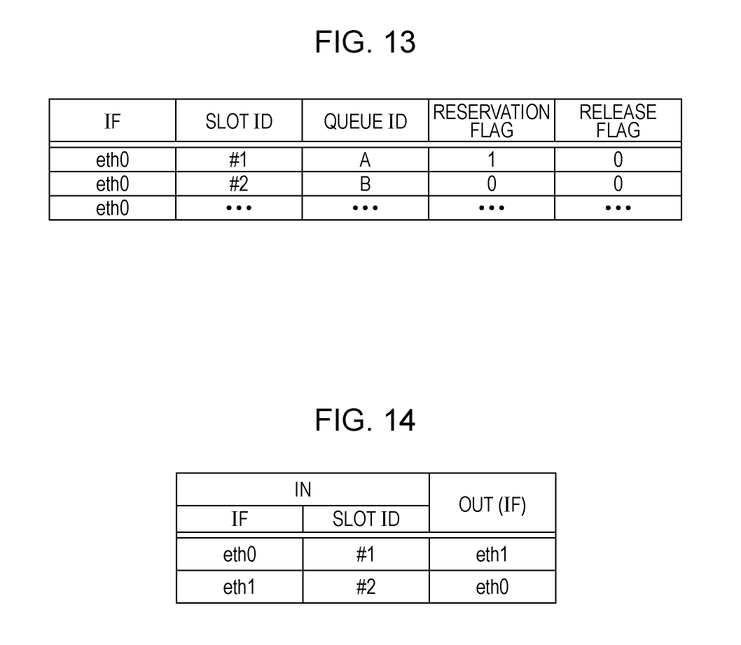

FIG. 13 illustrates an example of the slot reservation table stored in the slot reservation table storage 113. In the example of FIG. 13, the slot reservation table includes a column of “output interface (IF)”, a column of “slot ID”, a column of “queue ID”, a column of “reservation flag” (0: not yet reserved, and 1: already reserved), and a column of “release flag” (0: to be not released, and 1: to be released). In the column of “output interface (IF)”, an identifier of the output interface is set which is used in the packet communication performed in the time slot according to the relevant record. In the column of “queue ID”, an ID of the queue 1071 is set which stores the packet to be transmitted in the time slot according to the relevant record. Details of the reservation flag and the release flag are described later.

FIG. 14 illustrates an example of the slot table stored in the slot table storage 305. In the example of FIG. 14, the slot table includes a column of “input (IN)” and a column of “output interface (OUT(IF))”. The column of “input” is divided into a column of “input interface (IF)” and a column of “slot ID”. An identifier of the input interface and an identifier of the output interface, which are used in the packet communication performed in the time slot according to the relevant record, are set respectively in the column of “input interface” and the column of “output interface”.

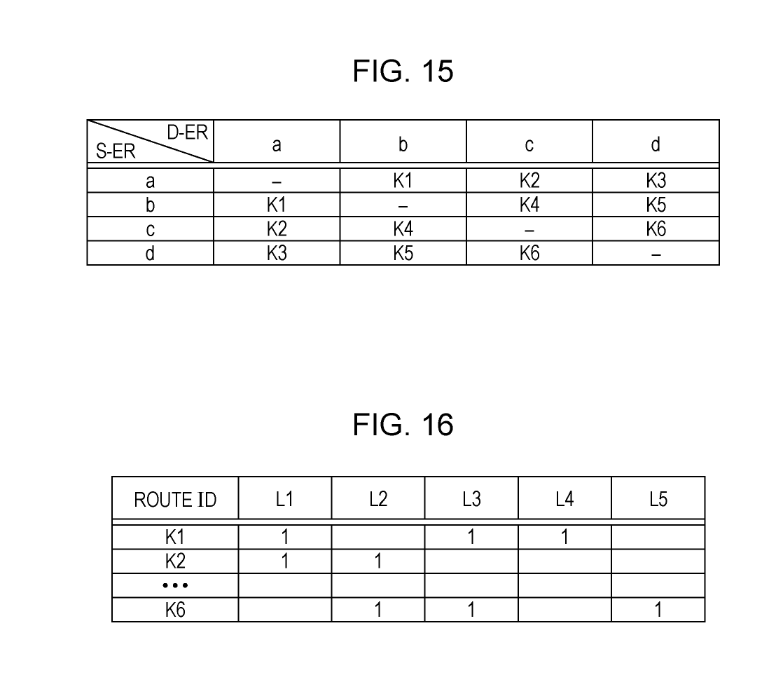

FIG. 15 illustrates an example of the route ID table stored in the route ID table storage 511. In the example of FIG. 15, columns of the route ID table are divided per identifier of the destination-edge router (D-ER), and rows of the route ID table are divided per identifier of the source-edge router (S-ER). Further, the route ID table stores, per combination between the source-edge router and the destination-edge router, a route ID corresponding to the combination.

FIG. 16 illustrates an example of the route/link management table stored in the route/link management table storage 513. In the example of FIG. 16, the route/link management table includes a column of “route ID” and a column per link ID (specifically, a column of “L1”, a column of “L2”, a column of “L3”, a column of “L4”, and a column of “L5” in FIG. 16). In the route/link management table, “1” is set for the link that is used in the route according to the relevant record. The table of FIG. 16 indicates, for example, that L1, L3 and L4 are used as the route having the route ID “K1”.

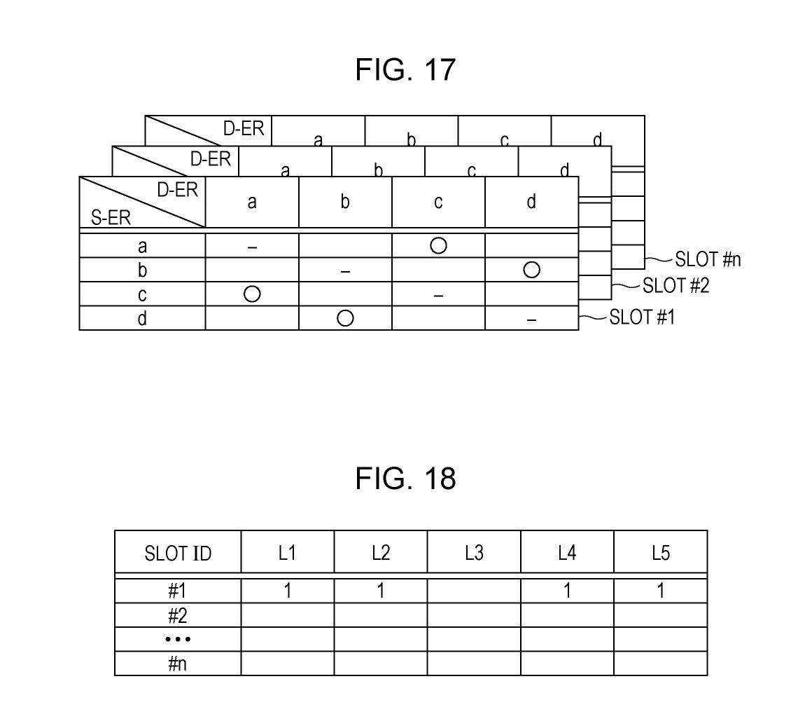

FIG. 17 illustrates an example of the slot assignment table stored in the slot assignment table storage 515. In the example of FIG. 17, columns of the slot assignment table are divided per identifier of the destination-edge router (D-ER), and rows of the slot assignment table are divided per identifier of the source-edge router (S-ER). Further, in the example of FIG. 17, the slot assignment table is held per slot ID (specifically, for each of the slot #1, the slot #2, the slot #3, etc.). A mark “◯” in the slot assignment table indicates that the time slot is assigned to the relevant combination between the source-edge router and the destination-edge router.

FIG. 18 illustrates an example of the link use situation table stored in the link use situation table storage 517. In the example of FIG. 18, the link use situation table includes a column of “slot ID” and a column per link ID (specifically, a column of “L1”, a column of “L2”, a column of “L3”, a column of “L4”, and a column of “L5” in FIG. 18). In the link use situation table, “1” is set for the link that is being used in the time slot according to the relevant record. The table of FIG. 18 indicates, for example, that L1, L2, L4 and L5 are being used in the slot #1.

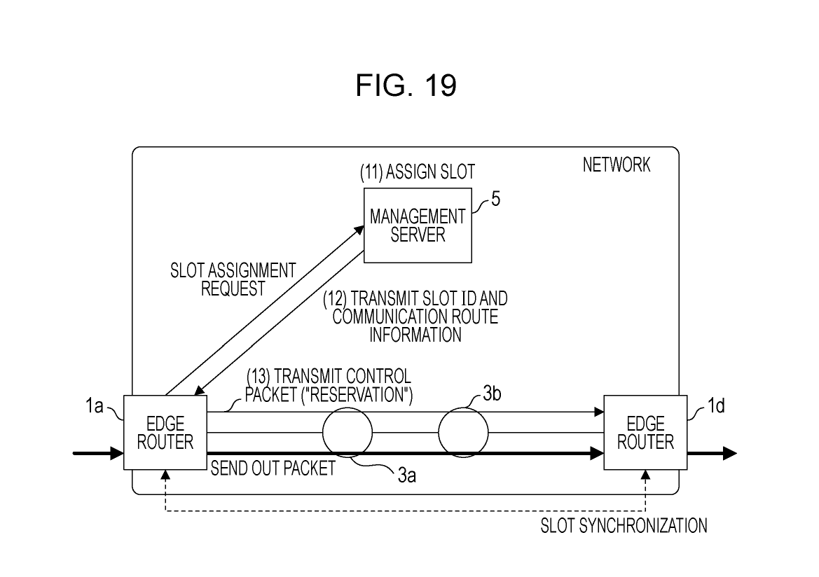

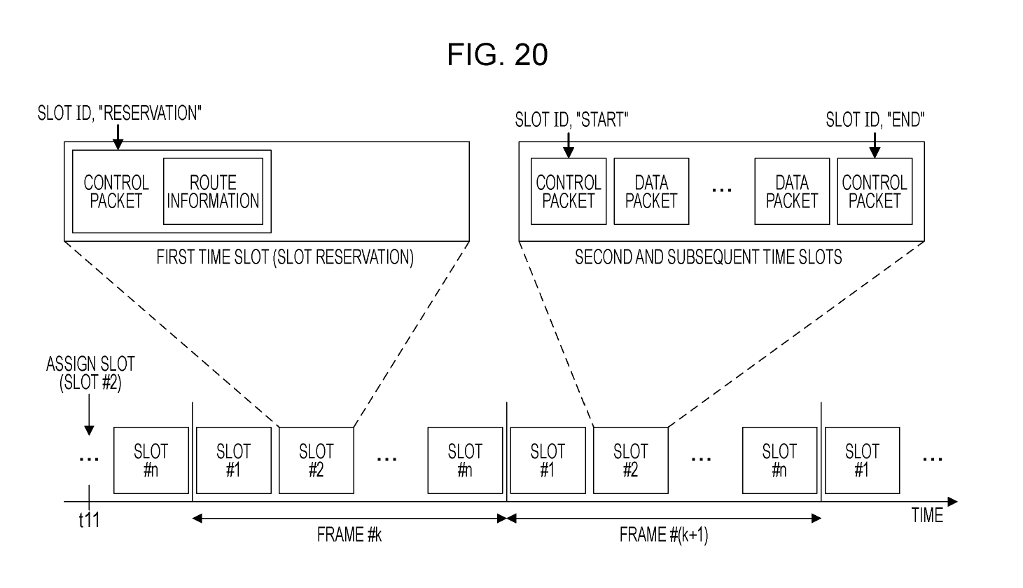

Prior to describing respective practical processing flows in the edge router 1, the relay router 3, and the management server 5 in the first embodiment, a description is first made for a processing flow in the entire packet communication system when the time slot is reserved and released, with reference to FIGS. 19 to 22. FIG. 19 illustrates processing executed in the entire packet communication system when the time slot is reserved. In other words, FIG. 19 illustrates details of the processing illustrated in FIG. 5.

Referring to FIG. 19, upon receiving the slot assignment request from the edge router 1a, the management server 5 assigns a time slot that will not cause any packet collisions, and then updates the slot assignment table and the link use situation table (FIG. 19: step (11)). Further, the management server 5 transmits an ID of the assigned time slot and communication route information to the edge router 1a (step (12)). The communication route information includes respective IP addresses of the relay routers 3 through which the packet passes until reaching the destination-edge router.

Upon receiving the time slot ID and the communication route information from the management server 5, the edge router 1a generates a new record based on the received data and adds the generated record to the slot reservation table. Then, upon detecting the switching-over to the assigned time slot, the edge router 1a transmits a control packet, which includes the time slot ID, the control type “reservation”, and the communication route information, in the assigned time slot to the edge router 1d (step (13)). The transmitted control packet reaches the edge router 1d through the relay router 3a and the relay router 3b. At that time, each of the relay router 3a and the relay router 3b generates a new record based on the data included in the control packet and adds the generated record to the relevant slot table.

After transmitting the control packet in the first time slot subsequent to the detection of the switching-over to the assigned time slot, the edge router 1a successively sends out a control packet including the time slot ID and the control type “start”, one or more data packets read out from the queue 1071, and a control packet including the time slot ID and the control type “end”.

FIG. 20 illustrates the case where, for example, the slot #2 is assigned. In the example of FIG. 20, because the time slot is assigned at a time t11, the time slot (slot #2) within a frame #k becomes a first time slot after the assignment. Thus, only a control packet (control type: reservation) is transmitted in the time slot (slot #2) within the frame #k. In the time slots (slots #2) within frames subsequent to the frame #(k+1), a control packet (control type: start), one or more data packets, and a control packet (control type: end) are transmitted in succession.

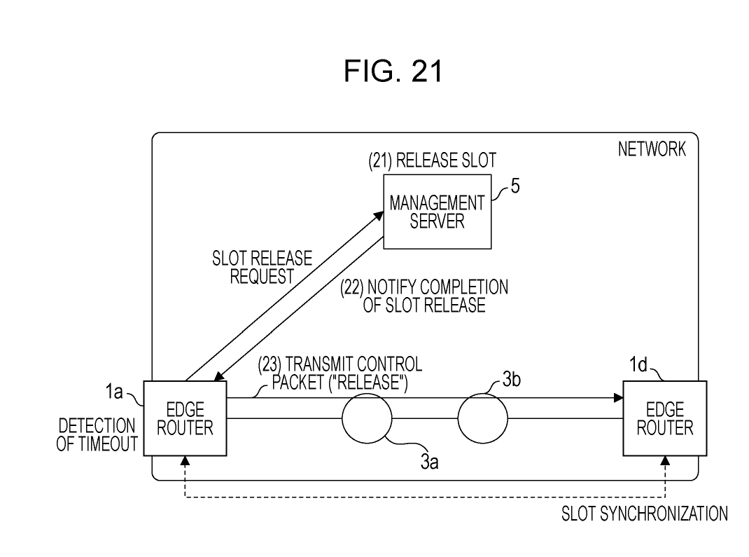

FIG. 21 illustrates a processing flow in the entire packet communication system when the time slot is released. In other words, FIG. 21 illustrates details of the processing illustrated in FIG. 7. Upon detecting a timeout of the timer, the edge router 1a, for example, transmits the slot release request to the management server 5. Upon receiving the slot release request from the edge router 1a, the management server 5 releases the time slot according to the slot release request and updates the slot assignment table and the link use situation table (FIG. 21: step (21)). Further, the management server 5 transmits a slot release completion notice, including the ID of the released time slot, to the edge router 1a (step (22)).

When the edge router 1a detects the switching-over to the released time slot after receiving the slot release completion notice from the management server 5, the edge router 1a transmits a control packet, which includes the time slot ID and the control type “release”, in the released time slot to the edge router 1d (step (23)). The relevant control packet reaches the edge router 1d through the relay router 3a and the relay router 3b. At that time, each of the relay router 3a and the relay router 3b deletes the record, which corresponds to the time slot ID included in the relevant control packet, from the slot table. Also, the edge router 1a deletes the record corresponding to the relevant time slot ID from the slot reservation table.

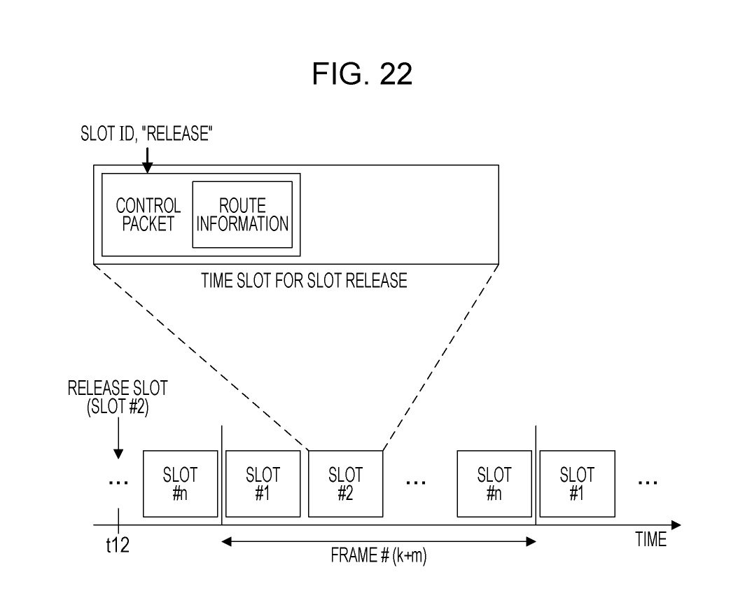

FIG. 22 illustrates the case where, for example, the slot #2 is released. In the example of FIG. 22, because the slot release completion notice is received at a time t12, the time slot (slot #2) within a frame #(k+m) becomes a first time slot after the release. Therefore, a control packet (control type: release) is transmitted in the time slot (slot #2) within the frame #(k+m).

According to the first embodiment, as described above, the time slot is reserved or released by the source-edge router transmitting the control packet, which includes the control type “reservation” or “release”, to the destination-edge router.

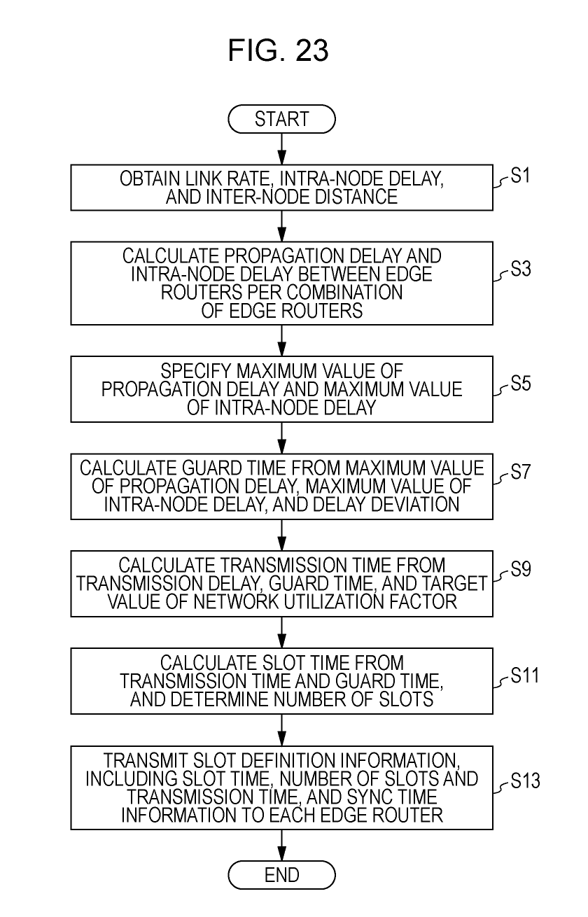

The respective practical processing flows in the edge router 1, the relay router 3, and the management server 5 will be described below with reference to FIGS. 23 to 35. For the sake of convenience in explanation, a processing flow of the management server 5 is first described.

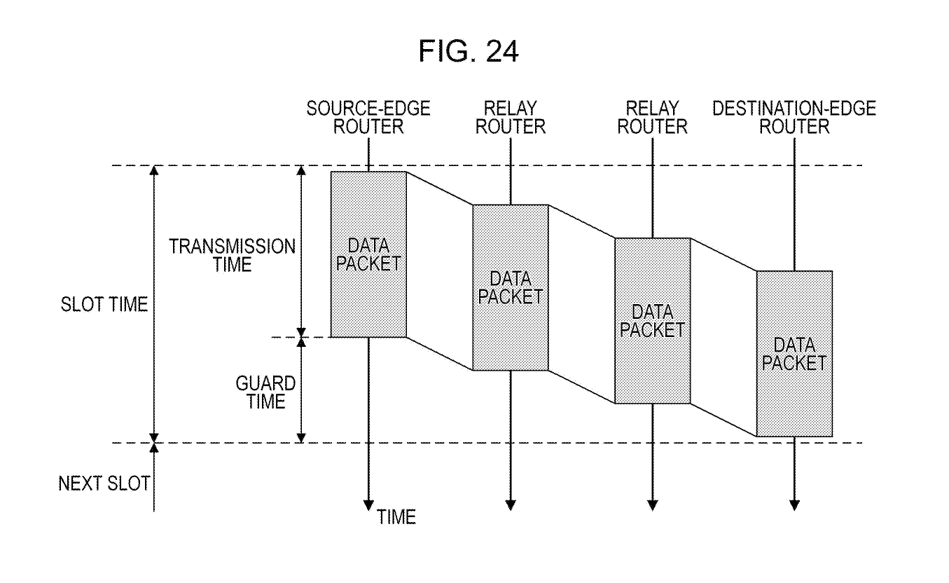

FIG. 23 illustrates the processing flow at the startup of the management server 5. After the startup of the management server 5, the control section 501 issues an SNMP command, for example, and collects information regarding the network configuration. Thus, the control section 501 obtains the link rate, the intra-node delay, and the inter-node distance which are set in advance (FIG. 23: step S1). By using the link rate, the intra-node delay, and the inter-node distance, the control section 501 calculates a propagation delay and a total intra-node delay between the edge routers per combination of the edge routers, and then stores the calculated results in a storage device (step S3). Further, the control section 501 specifies a maximum value of the propagation delay between the edge routers and a maximum value of the intra-node delay between the edge routers per combination of the edge routers (step S5). After calculating a deviation (e.g., 10%) of those delays, the control section 501 calculates a guard time from the maximum value of the propagation delay between the edge routers, the maximum value of the intra-node delay between the edge routers, and the delay deviation, and then stores the calculated guard time in the storage device (step S7). The guard time is now described with reference to FIG. 24. As illustrated in FIG. 24, the packet transmitted from the source-edge router reaches the destination-edge router with a delay from the transmitted time because of a physical delay (such as a propagation delay). In this embodiment, therefore, the guard time is set within a slot time to ensure that the packet reaches the destination-edge router within the slot time. The guard time can be calculated, for example, based on the following formula:

guard time=maximum value of propagation delay between edge routers+maximum value of intra-node delay between edge routers+delay deviation

Further, the control section 501 calculates a transmission time by using the calculated guard time as well as the preset network (NW) utilization factor (target value) and transmission delay (step S9). It is here assumed that the network utilization factor is defined by the following formula (I). In other words, the transmission time can be calculated by putting the calculated guard time as well as the preset network utilization factor (target value) and transmission delay in the formula (I). While the slot time is given by (transmission time+guard time) as illustrated in FIG. 24, it is required to prolong the transmission time and to transmit plural packets together for the purpose of increasing the network utilization factor.

network utilization factor=transmission delay/(transmission time+guard time) (1)

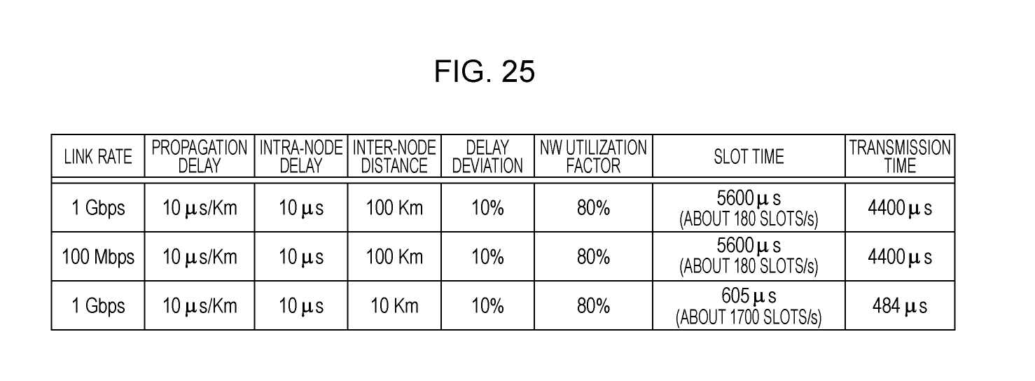

Then, the control section 501 calculates a slot time from both the transmission time calculated in step S9 and the guard time calculated in step S7, thus determining the number of slots (step S11). The slot time is calculated based on the relationship of (slot time=transmission time+guard time). FIG. 25 illustrates examples of calculation of the slot time.

Then, the control section 501 transmits slot definition information, including the slot time, the number of slots, and the transmission time, and sync time information, to each of the edge routers 1 (step S13). The processing is then brought to an end.

With the processing executed as described above, the data necessary for synchronizing the time slot is delivered to each edge router 1.

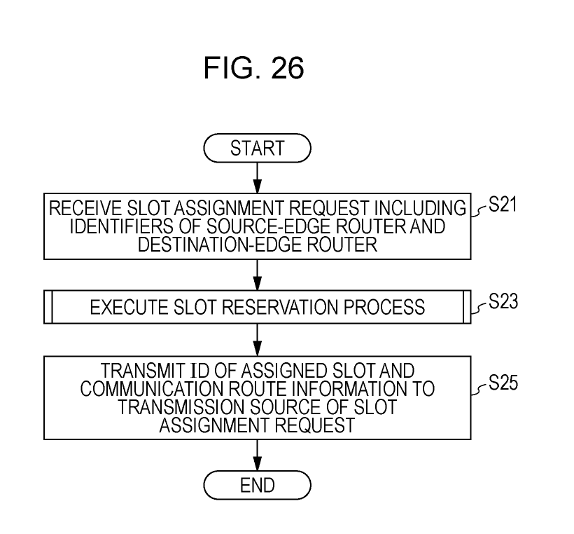

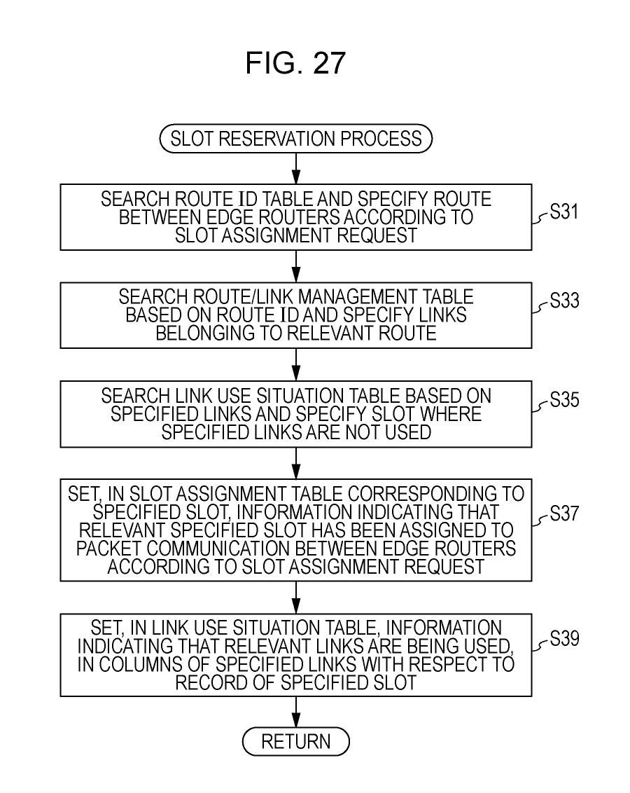

A processing flow in the management server 5 when the time slot is reserved will be described below with reference to FIGS. 26 and 27. Whenever the management server 5 receives the slot assignment request from the edge router 1, the management server 5 executes processing illustrated in FIG. 26. First, the input section 503 receives the slot assignment request, including the respective identifiers of the source-edge router and the destination-edge router, from the edge router 1 and temporarily stores the slot assignment request in the storage device (FIG. 26: step S21). Further, the input section 503 notifies the slot reservation processing section 505 of the fact that the slot assignment request has been received.

Upon receiving the notification from the input section 503, the slot reservation processing section 505 executes a slot reservation process by using the route ID table, the route/link management table, the slot assignment table, and the link use situation table (step S23). The slot reservation process is now described with reference to FIG. 27.

First, the slot reservation processing section 505 searches the route ID table based on the respective identifiers of the source-edge router and the destination-edge router, which are included in the slot assignment request stored in the storage device, and specifies the route between the edge routers according to the slot assignment request (FIG. 27: step S31). Further, the slot reservation processing section 505 searches the route/link management table based on the ID of the specified route and specifies one or more links which belong to the relevant route (step S33).

Then, the slot reservation processing section 505 searches the link use situation table based on the ID of the specified link and specifies a slot where the specified link is not used (step S35). If a plurality of links are specified in step S33, the slot reservation processing section 505 specifies a slot where the plurality of links are all not used. Further, the slot reservation processing section 505 sets, in the slot assignment table corresponding to the specified slot, information (i.e., the mark “◯” in FIG. 17) indicating that the relevant specified slot has been assigned to the packet communication between the edge routers according to the slot assignment request (step S37). In addition, the slot reservation processing section 505 sets, in link use situation table, information (i.e., “1” in FIG. 18) indicating that the relevant links are being used, in the columns of the specified links with respect to the record of the specified slot (step S39). Thereafter, the slot reservation process is brought to an end, followed by returning to the main processing flow of FIG. 26.

Returning to the description of FIG. 26, after executing the slot reservation process, the slot reservation processing section 505 notifies the ID of the assigned slot and the communication route information to the output section 509. Upon receiving the notification from the slot reservation processing section 505, the output section 509 transmits the ID of the assigned slot and the communication route information to the transmission source which has transmitted the slot assignment request (step S25). The processing of FIG. 26 is then brought an end.

With the processing executed as described above, the management server 5 assigns the time slot where the links belonging to the communication route are all not used. Therefore, when the packet communication is performed in the relevant time slot, a packet collision with any other packets does not occur.

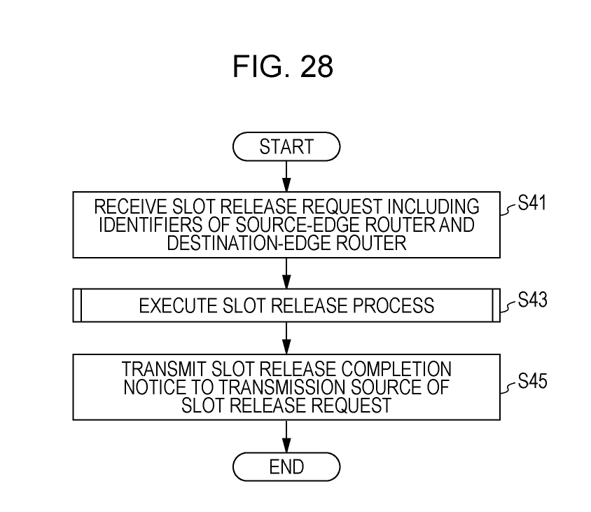

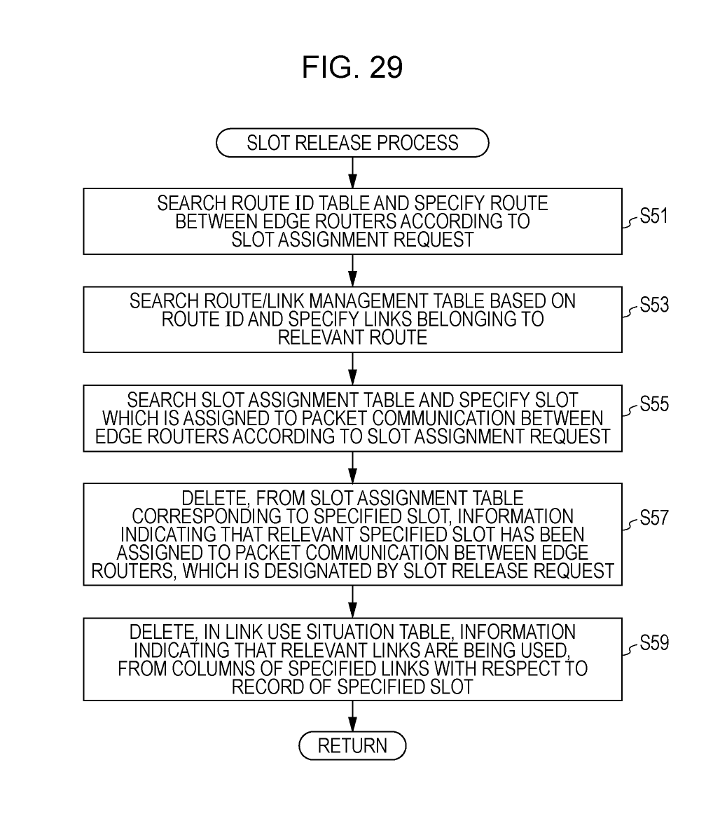

A processing flow in the management server 5 when the time slot is released will be described below with reference to FIGS. 28 and 29. Whenever the management server 5 receives the slot release request from the edge router 1, the management server 5 executes processing illustrated in FIG. 28. First, the input section 503 receives the slot release request, including the respective identifiers of the source-edge router and the destination-edge router, from the edge router 1 and temporarily stores the slot release request in the storage device (FIG. 28: step S41). Further, the input section 503 notifies the slot release processing section 507 of the fact that the slot release request has been received.

Upon receiving the notification from the input section 503, the slot release processing section 507 executes a slot release process by using the route ID table, the route/link management table, the slot assignment table, and the link use situation table (step S43). The slot release process is now described with reference to FIG. 297.

First, the slot release processing section 507 searches the route ID table based on the respective identifiers of the source-edge router and the destination-edge router, which are included in the slot release request stored in the storage device, and specifies the route between the edge routers according to the slot release request (FIG. 29: step S51). Further, the slot release processing section 507 searches the route/link management table based on the ID of the specified route and specifies one or more links which belong to the relevant route (step S53).

Then, the slot release processing section 507 searches the slot assignment table based on the respective identifiers of the source-edge router and the destination-edge router, which are included in the slot release request stored in the storage device, and specifies the slot that is assigned to the packet communication between the edge routers according to the slot release request (step S55). Further, the slot release processing section 507 deletes, from the slot assignment table corresponding to the specified slot, the information (i.e., the mark “◯” in FIG. 17) indicating that the relevant specified slot has been assigned to the packet communication between the edge routers, which is designated by the slot release request (step S57). In addition, the slot release processing section 507 deletes, in the link use situation table, the information (i.e., “1” in FIG. 18) indicating that the relevant links are being used, in the columns of the specified links with respect to the record of the specified slot (step S59). Thereafter, the slot release process is brought to an end, followed by returning to the main processing flow of FIG. 28.

Returning to the description of FIG. 28, after executing the slot release process, the slot release processing section 507 notifies the ID of the released slot to the output section 509. Upon receiving the notification from the slot release processing section 507, the output section 509 transmits a slot release completion notice, including the ID of the released slot, to the transmission source which has transmitted the slot release request (step S45). The processing of FIG. 28 is then brought an end.

With the processing executed as described above, the slot assignment table and the link use situation table are appropriately updated corresponding to the release of the time slot. Therefore, the relevant time slot can be assigned to another packet communication.

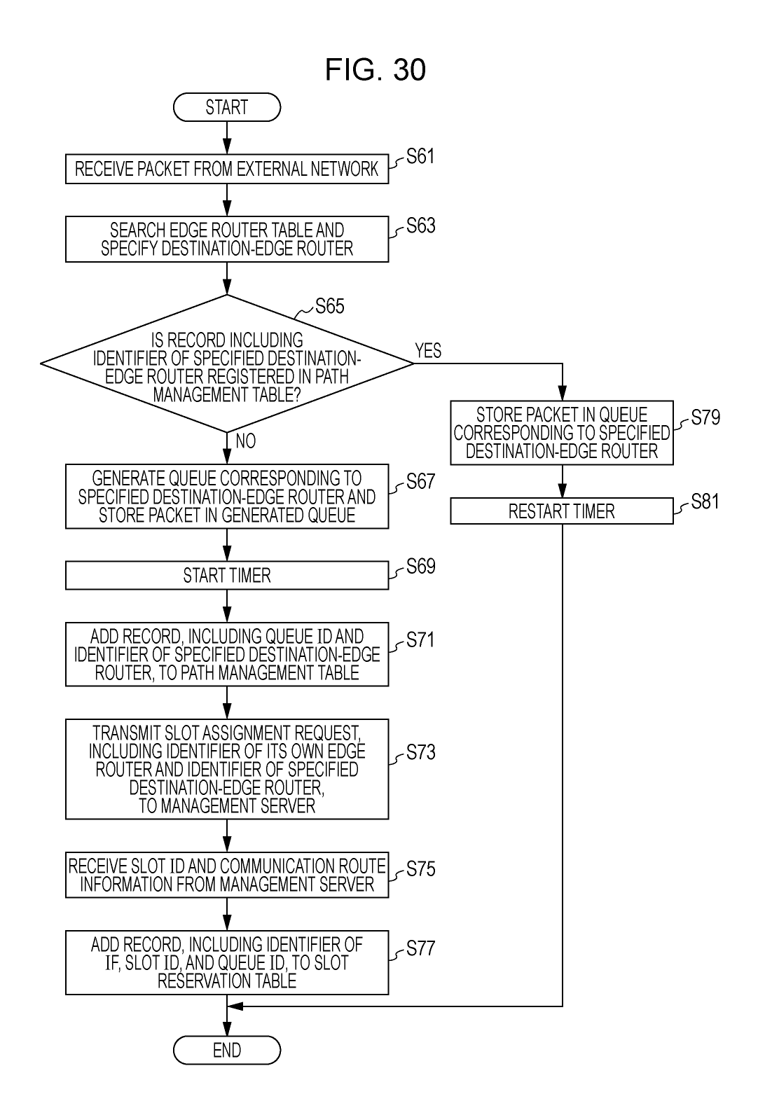

A processing flow in the edge router 1 will be described below with reference to FIGS. 30 to 33. FIG. 30 illustrates a processing flow when a time slot is newly assigned. First, the packet receiving section 101 receives a packet from the external network (FIG. 30: step S61) and outputs the received packet to the packet classifying section 107. Upon receiving the packet from the packet receiving section 101, the packet classifying section 107 searches the edge router table based on the address of the transmission destination for the relevant packet and specifies the identifier of the destination-edge router (step S63).

Then, the packet classifying section 107 determines whether a record including the identifier of the specified destination-edge router is registered in the path management table (step S65). If it is determined that the record including the identifier of the specified destination-edge router is not registered in the path management table (step S65: No route), the packet classifying section 107 generates the queue 1071 corresponding to the specified destination-edge router and stores the packet in the generated queue 1071 (step S67). Further, the packet classifying section 107 starts a timer corresponding to the generated queue 1071 (step S69). The packet classifying section 107 generates a record including the queue ID and the identifier of the specified destination-edge router, and then adds the generated record to the path management table (step S71). Still further, the packet classifying section 107 determines that assignment of a time slot is required, and notifies the determination result to the slot reserving section 111.

Upon receiving the notification from the packet classifying section 107, the slot reserving section 111 transmits a slot assignment request, including the identifier of the edge router to which the slot reserving section 111 belongs and the identifier of the specified destination-edge router, to the management server 5 (step S73).

Thereafter, the slot reserving section 111 receives, as a response to the slot assignment request, the slot ID and the communication route information from the management server 5 and temporarily stores them in a storage device (step S75). In accordance with the communication route information, the slot reserving section 111 specifies an interface from the edge router table and a queue ID from the path management table. Further, the slot reserving section 111 generates a record including the identifier of the interface, the slot ID, and the queue ID, and then adds the generated record to the slot reservation table (step S77). The processing of FIG. 30 is then brought to an end.

On the other hand, if it is determined in step S65 that the record including the identifier of the specified destination-edge router is registered in the path management table (step S65: Yes route), the packet classifying section 107 stores the packet in the queue 1071 corresponding to the specified destination-edge router (step S79). Further, the packet classifying section 107 restarts a timer corresponding to the relevant queue 1071 (step S81).

With the processing executed as described above, the edge router can transmit the slot assignment request to the management server 5, as required, and can receive the assignment of the time slot.

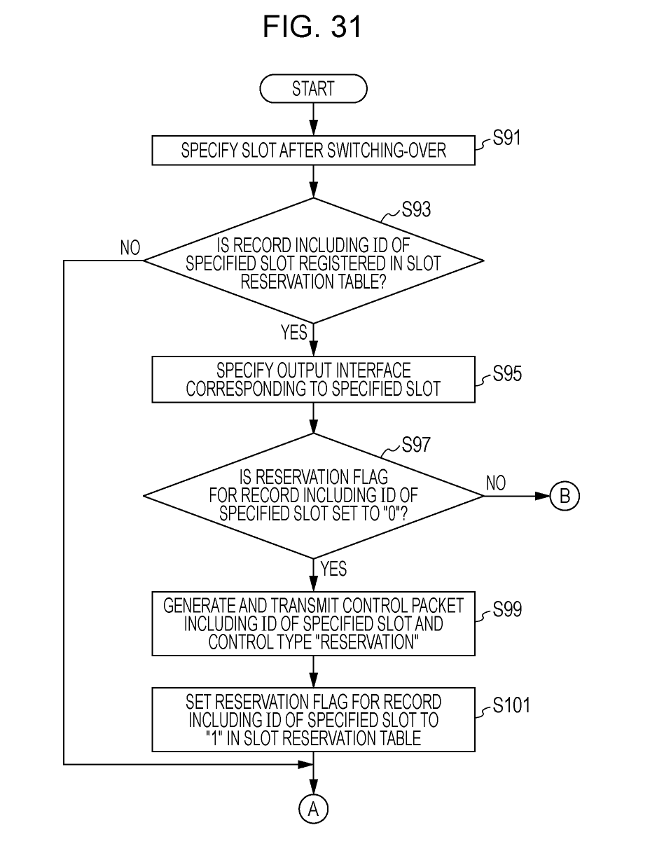

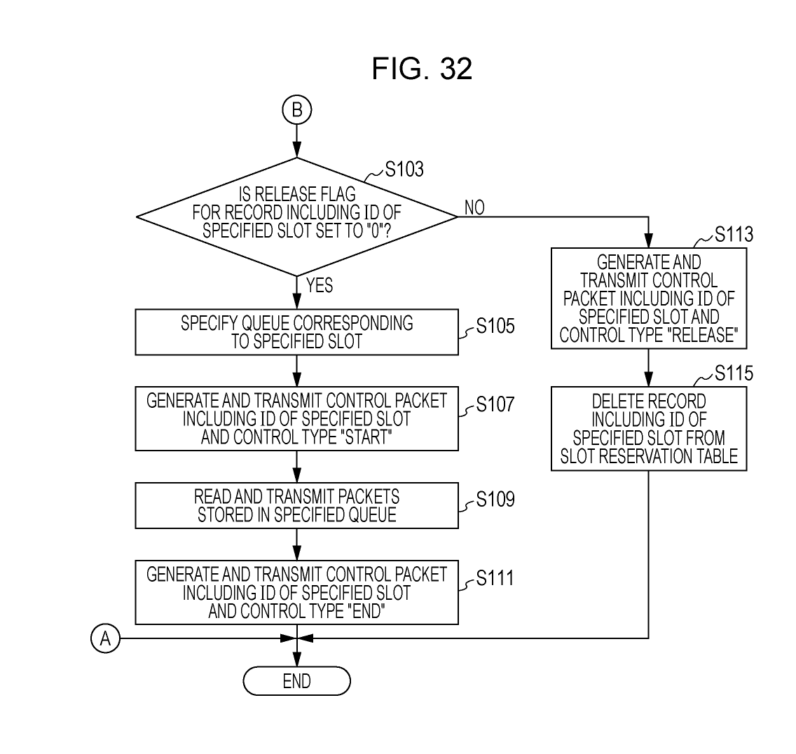

A processing flow in the edge router 1 when the time slot is switched over will be described below with reference to FIGS. 31 and 32. Whenever the time slot is switched over, the edge router 1 executes processing illustrated in FIGS. 31 and 32. For example, in a sequential stream of time slots specified by the slot definition information, the scheduling section 115 detects switching-over of the time slot based on the sync time information. Be it noted that synchronization of the time slot can be established by each edge router 1 switching over the time slot in accordance with the sync time information. If the switching-over of the time slot is detected, the scheduling section 115 specifies a slot after the switching-over (FIG. 31: step S91).

Then, the scheduling section 115 determines whether a record including the ID of the specified slot is registered in the slot reservation table (step S93). If it is determined that the record including the ID of the specified slot is not registered in the slot reservation table (step S93: No route), the processing of FIG. 31 is brought to an end through a flow junction point A.

On the other hand, if it is determined that the record including the ID of the specified slot is registered in the slot reservation table (step S93: Yes route), the scheduling section 115 specifies an output interface corresponding to the specified slot from the slot reservation table (step S95).

Then, the scheduling section 115 determines whether a reservation flag for the record including the ID of the specified slot is “0” (which means that the specified slot is not reserved) in the slot reservation table (step S97). If it is determined that the reservation flag for the record including the ID of the specified slot is “1” (which means that the specified slot is reserved) in the slot reservation table (step S97: No route), the scheduling section 115 shifts to processing of step S103 (FIG. 32) through a flow junction point B.

On the other hand, if it is determined that the reservation flag for the record including the ID of the specified slot is “0” (i.e., the absence of reservation) in the slot reservation table (step S97: Yes route), the scheduling section 115 generates a control packet including the ID of the specified slot, the control type “reservation”, and the communication route information, and then transmits the generated control packet to the destination-edge router through the specified output interface (step S99). Further, the scheduling section 115 sets the reservation flag for the record including the ID of the specified slot to “1” (i.e., the presence of reservation) in the slot reservation table (step S101). The processing of FIG. 31 is then brought to an end through the flow junction point A. Be it noted that steps S99 and S101 represent the processing related to the first time slot after the slot assignment.

Turning now to a description of FIG. 32, after the flow junction point B, the scheduling section 115 determines whether a release flag for the record including the ID of the specified slot is “0” (which means that the specified slot is not released) in the slot reservation table (FIG. 32: step S103). If it is determined that the release flag for the record including the ID of the specified slot is “0” (i.e., no release) in the slot reservation table (step S103: Yes route), the scheduling section 115 specifies the queue 1071 corresponding to the specified slot (step S105). Further, the scheduling section 115 generates a control packet including the ID of the specified slot and the control type “start” and transmits the generated control packet to the destination-edge router through the specified output interface (step S107). The scheduling section 115 successively reads, from the specified queue 1071, data packets which are to be transmitted to the destination-edge router through the specified output interface, and then transmits the data packets to the destination-edge router through the specified output interface (step S109). An upper limit of the number of packets transmittable in the time slot is determined depending on the transmission time. Still further, the scheduling section 115 generates a control packet including the ID of the specified slot and the control type “end”, and then transmits the generated control packet to the destination-edge router through the specified output interface (step S111). Thereafter, the processing of FIG. 32 is brought to an end. Be it noted that steps S105 and 5111 represent the processing related to the second and subsequent time slots after the slot assignment.

On the other hand, if it is determined that the release flag for the record including the ID of the specified slot is “1” (i.e., release) in the slot reservation table (step S103: No route), the scheduling section 115 generates a control packet including the ID of the specified slot and the control type “release”, and then transmits the generated control packet to the destination-edge router through the specified output interface (step S113). Further, the scheduling section 115 deletes the record including the ID of the specified slot from the slot reservation table (step S115). Thereafter, the processing of FIG. 32 is brought to an end.

With the processing executed as described above, since the packet is sent out in accordance with the assignment made by the management server 5, communication between the edge routers can be performed without causing any packet collisions.

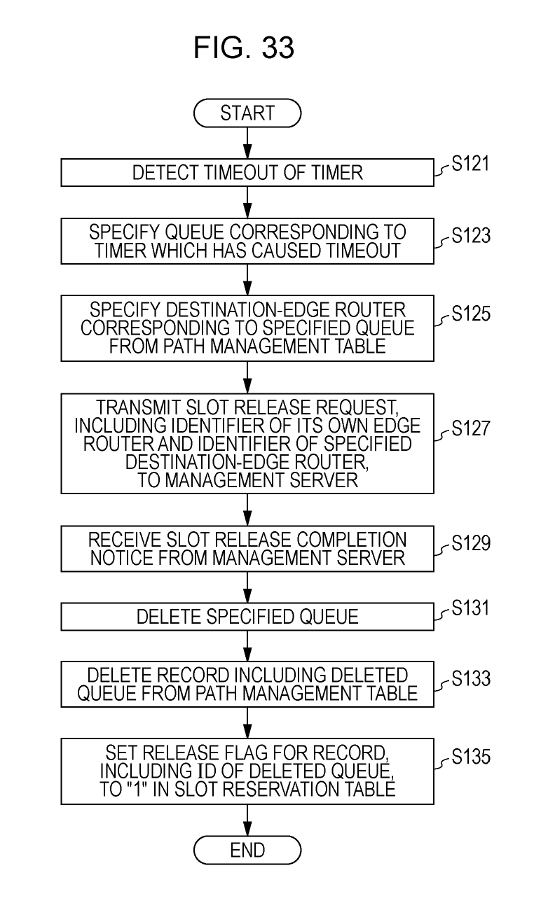

A processing flow in the edge router 1 when a timeout of the timer is detected will be described below with reference to FIG. 33. As described above, the packet classifying section 107 starts or restarts the timer when the packet is stored in the queue 1071. Therefore, a timeout occurs unless a new packet is stored within a certain time. The following description is made on the premise that the timer corresponding to any of the queues 1071 has caused a timeout.

First, the slot releasing section 117 detects a timeout of the timer corresponding to any of the queues 1071 (FIG. 33: step S121). Further, the slot releasing section 117 specifies the queue 1071 corresponding to the timer which has caused the timeout (step S123). The slot releasing section 117 specifies a destination-edge router corresponding to the specified queue 1071 from the path management table (step S125). Still further, the slot releasing section 117 transmits a slot release request, including the identifier of the edge router to which the slot releasing section 117 belongs and the identifier of the specified destination-edge router, to the management server 5 (step S127).

Thereafter, the slot releasing section 117 receives a slot release completion notice including the ID of the released slot from the management server 5 and temporarily stores the received slot release completion notice in the storage device (step S129). Further, the slot releasing section 117 outputs, to the packet classifying section 107, an instruction for deleting the specified queue 1071. In response to the instruction from the slot releasing section 117, the packet classifying section 107 deletes the specified queue 1071 (step S131).

Then, the slot releasing section 117 deletes the record including the ID of the deleted queue 1071 from the path management table (step S133). Further, the slot releasing section 117 sets the release flag for the record, which includes the ID of the deleted queue 1071, to 1 (i.e., release) in the slot reservation table (step S135). The processing of FIG. 33 is then brought to an end.

With the processing executed as described above, when a packet is not received for a certain time or longer, the assigned time slot is released such that the relevant time slot can be reassigned to another packet communication.

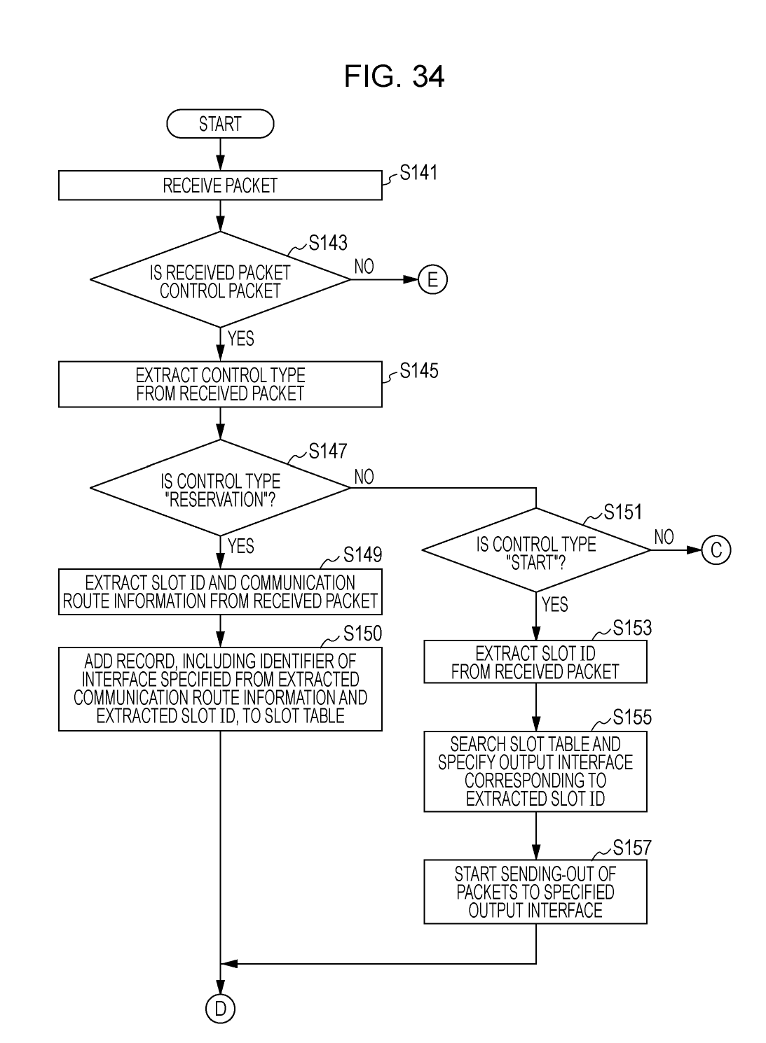

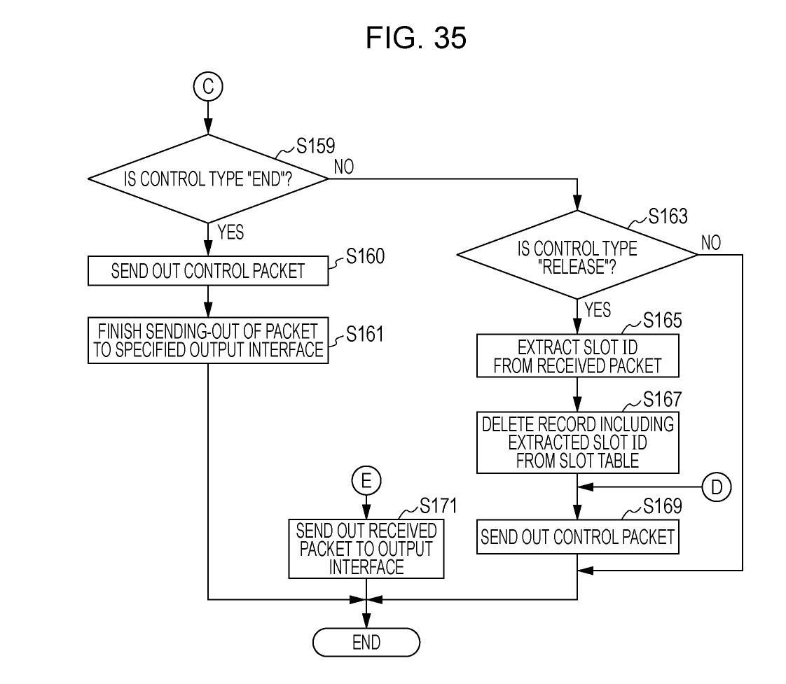

A processing flow in the relay router 3 will be described below with reference to FIGS. 34 and 35. First, the forwarding engine 307 receives a packet from the adjacent edge router 1 or the other relay router 3 through the line card 301 (FIG. 34: step S141). Further, the forwarding engine 307 determines whether the received packet is the control packet (step S143). If it is determined that the received packet is not the control packet (step S143: No route), the forwarding engine 307 shifts to processing of step S171 (FIG. 35) through a flow junction point E.

On the other hand, if it is determined that the received packet is the control packet (step S143: Yes route), the forwarding engine 307 extracts the control type from the received packet (step S145). Further, the forwarding engine 307 determines whether the extracted control type is “reservation” (step S147). If it is determined that the extracted control type is “reservation” (step S147: Yes route), the forwarding engine 307 extracts the slot ID and the communication route information from the received packet (step S149). As illustrated in FIG. 20, for example, the communication route information is included in the control packet having the control type “reservation”.

Then, the forwarding engine 307 generates a record including both the identifier of an interface, which is specified based on the extracted communication route information, and the extracted slot ID, and adds the generated record to the slot table (step S150). For example, the forwarding engine 307 specifies, from the communication route information, the relay router 3 through which the packet is going to pass next, and further specifies, from the IF table, the interface connected to the specified relay router 3. Thereafter, the forwarding engine 307 shifts to processing of step S169 (FIG. 35) through a flow junction point D.

On the other hand, if it is determined that the extracted control type is not “reservation” (step S147: No route), the forwarding engine 307 determines whether the extracted control type is “start” (step S151). If it is determined that the extracted control type is “start” (step S151: Yes route), the forwarding engine 307 extracts the slot ID from the received packet (step S153). Further, the forwarding engine 307 searches the slot table and specifies an output interface corresponding to the extracted slot ID (step S155), followed by starting to send out packets to the specified output interface (step S157). Stated another way, the forwarding engine 307 sends out packets from the input interface to the specified output interface until the control packet (control type: “end”) is received, without searching the routing table. The forwarding engine 307 then shifts to processing of step S169 (FIG. 35) through the flow junction point D.

On the other hand, if it is determined that the extracted control type is not “start” (step S151: No route), the forwarding engine 307 shifts to processing of step S159 (FIG. 35) through a flow junction point C.

Turning now to FIG. 35, after the flow junction point C, the forwarding engine 307 determines whether the extracted control type is “end” (FIG. 35; step S159). If it is determined that the extracted control type is “end” (step S159: Yes route), the forwarding engine 307 sends out the received packet (control packet) to the adjacent edge router 1 or the other relay router 3 through the specified output interface (step S160). Further, the forwarding engine 307 finishes the sending-out of packets to the specified output interface (step S161). The processing of FIG. 35 is then brought to an end.

On the other hand, if it is determined that the extracted control type is not “end” (step S159: No route), the forwarding engine 307 determines whether the extracted control type is “release” (step S163). If it is determined that the extracted control type is “release” (step S163: Yes route), the forwarding engine 307 extracts the slot ID from the received packet (step S165). Further, the forwarding engine 307 deletes the record including the extracted slot ID from the slot table (step S167). The forwarding engine 307 then shifts to the processing of step S169.

On the other hand, if it is determined that the extracted control type is not “release” (step S163: No route), the processing of FIG. 35 is brought to an end.

After the flow junction point D or after the processing of step S167, the forwarding engine 307 sends out the received packet (control packet) to the adjacent edge router 1 or the other relay router 3 (step S169) and brings the processing of FIG. 35 to an end.

Also, after the flow junction point E, the forwarding engine 307 sends out the received packet (data packet) to the specified output interface (step S171) and brings the processing of FIG. 35 to an end.

With the processing executed as described above, the relay router 3 can properly relay the data packet without executing the routing process. Further, since, as described above, the time slot is assigned so as not to cause any packet collisions, the relay router 3 is not required to execute the packet buffering process. In other words, power consumed in the packet buffering process and the routing process can be cut, and hence power saving can be achieved in the relay router 3.

Assuming the power consumption in the known entire network to be 1, for example, the power consumption in the packet communication system of this embodiment is estimated as follows. It is also assumed that a ratio of the number of edge routers 1 to the number of relay routers 3 is given by (number of edge routers 1): (number of relay routers 3)=1:2. Further, it is assumed that a percentage of the power consumption by the packet buffering process and the routing process in the relay router 3 is 37% of the total power consumption in the relay router 3. Such a value (37%) is based on, e.g., Non-patent Document reported by J. Baliga, R. Ayre, K. Hinton and R. S. Tucker, “Photonic Switch and the Energy Bottleneck”, Proc. IEEE Photonics in Switching, August 2007. The value (37%) is the sum of 33.5% for “Forwarding engine” and 3.5% for “Buffers”. Moreover, the power consumption in the edge router 1 is assumed to be the same as that in the related art. In addition, the power consumption in the management server 5 is so small as to be negligible in comparison with the total power consumption in many edge routers 1 and many relay routers 3.

Power consumption in the packet communication system of this embodiment=1×(⅓)+(1−0.37)×(⅔)≈0.75

Thus, according to the packet communication system of this embodiment, a power saving of 25% can be achieved in the entire network in comparison with the related art.

### Second Embodiment

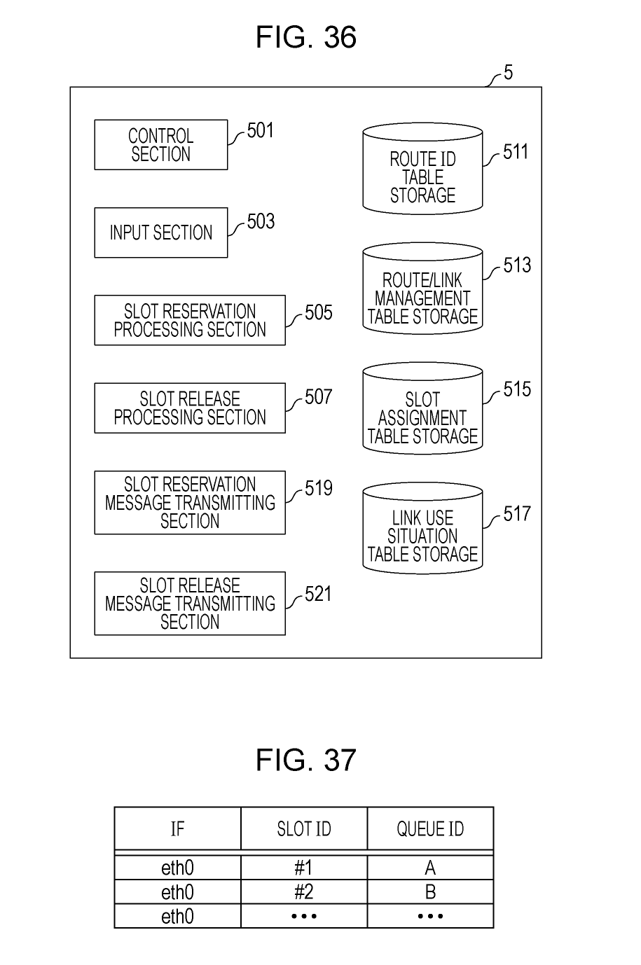

A second embodiment of the present technique will be described below with reference to FIGS. 36 to 47. In the first embodiment described above, the time slot is reserved or released by the source-edge router transmitting the control packet (control type: “reservation” or “release”). In the second embodiment, however, the time slot is reserved or released by the management server 5 transmitting a control message to each of the edge routers 1 and the relay routers 3.

FIG. 36 is a functional block diagram of the management server 5 in the second embodiment. The management server 5 in the second embodiment includes a control section 501, an input section 503, a slot reservation processing section 505, a slot release processing section 507, a slot reservation message transmitting section 519, a slot release message transmitting section 521, a route ID table storage 511, a route/link management table storage 513, a slot assignment table storage 515, and a link use situation table storage 517. The control section 501, the input section 503, the slot reservation processing section 505, the slot release processing section 507, the route ID table storage 511, the route/link management table storage 513, the slot assignment table storage 515, and the link use situation table storage 517 are basically the same as those in the first embodiment.

The slot reservation message transmitting section 519 executes a process of transmitting a slot reservation message, which will be described later. The slot release message transmitting section 521 executes a process of transmitting a slot release message, which will be described later.

Respective functional block diagrams of the edge router 1 and the relay router 3 are basically the same as those illustrated in FIGS. 8 and 9 except for that, in the second embodiment, a slot reservation table illustrated in FIG. 37 is stored in the slot reservation table storage 113 of the edge router 1. In an example of FIG. 37, the slot reservation table includes a column of “output interface (IF)”, a column of “slot ID”, and a column of “queue ID”. Stated another way, the slot reservation table of FIG. 37 is provided by excluding the column of “reservation flag” and the column of “release flag” from the slot reservation table (FIG. 13) in the first embodiment.

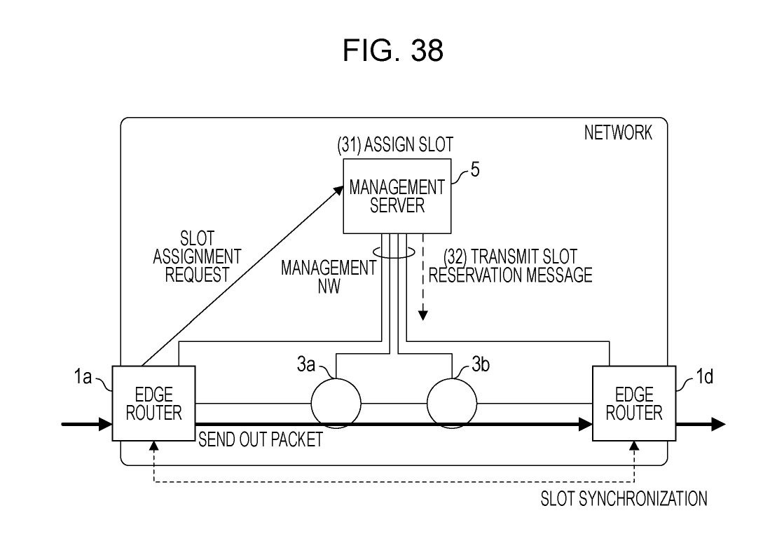

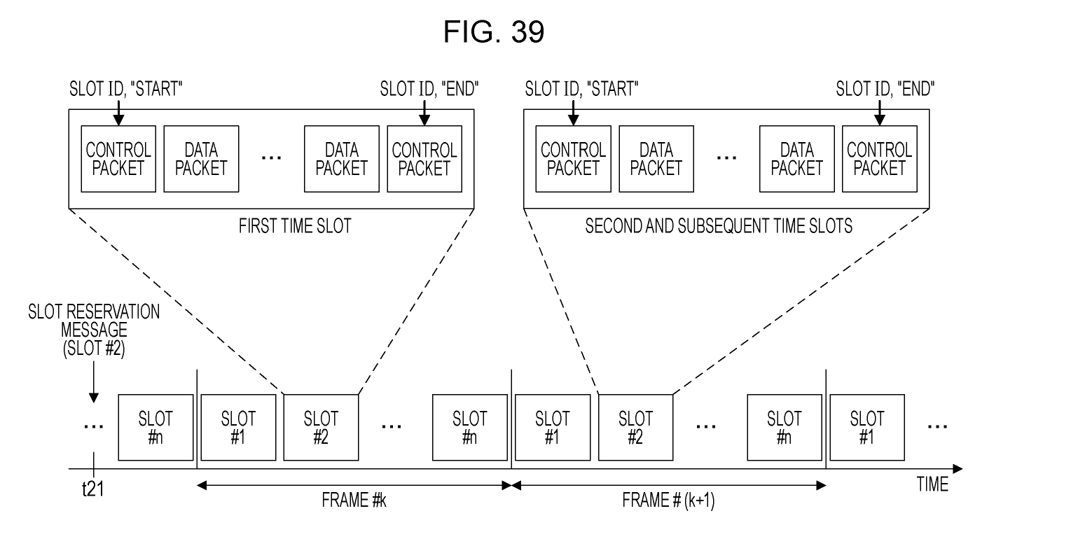

A processing flow in the entire packet communication system when the time slot is reserved will be described below with reference to FIGS. 38 and 39. It is assumed in the second embodiment that, as illustrated in FIG. 38, a management network (NW) for control traffic is constructed between each of the edge routers 1 and the relay routers 3 and the management server 5.

Referring to FIG. 38, upon receiving the slot assignment request from the edge router 1a, the management server 5 assigns a time slot that will not cause any packet collisions, and then updates the slot assignment table and the link use situation table (FIG. 38: step (31)). Further, the management server 5 transmits a slot reservation message including an ID of the assigned time slot and communication route information to each of the edge router 1a, the relay router 3a, the relay router 3b, and the edge router 1d (step (32)).

Upon receiving the slot reservation message from the management server 5, each of the edge router 1a, the relay router 3a, the relay router 3b, and the edge router 1d generates a new record based on data included in the received slot reservation message, and further adds the generated record to the slot reservation table or the slot table.

Then, upon detecting the switching-over to the assigned time slot, the edge router 1a successively sends out a control packet including the time slot ID and the control type “start”, one or more data packets read out from the queue 1071, and a control packet including the time slot ID and the control type “end”.

FIG. 39 illustrates the case where, for example, the slot #2 is assigned. In the example of FIG. 39, because the slot reservation message is received at a time t21, the time slot (slot #2) within a frame #k becomes a first time slot after the assignment. Be it noted that the control packet (control type: reservation) is not required to be transmitted in the second embodiment. Therefore, the control packet (control type: start), one or more data packets, and the control packet (control type: end) are transmitted in the first slot time as well.

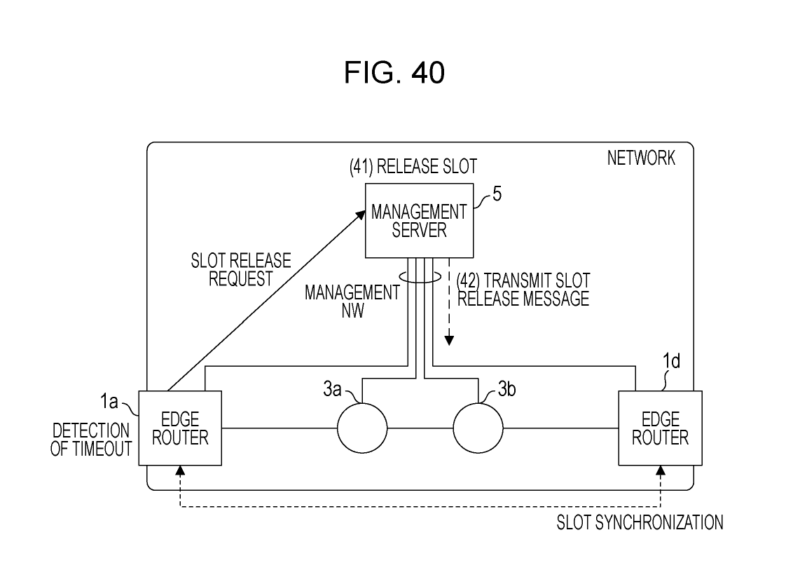

FIG. 40 illustrates a processing flow in the entire packet communication system when the time slot is released. Upon detecting a timeout of the timer, the edge router 1a, for example, transmits the slot release request to the management server 5. Upon receiving the slot release request from the edge router 1a, the management server 5 releases the time slot according to the slot release request and updates the slot assignment table and the link use situation table (FIG. 40: step (41)). Further, the management server 5 transmits a slot release message, including the ID of the released time slot, to each of the edge router 1a, the relay router 3a, the relay router 3b, and the edge router 1d (step (42)).

Upon receiving the slot release message from the management server 5, each of the edge router 1a, the relay router 3a, the relay router 3b, and the edge router 1d deletes the record including the ID of the released time slot from the slot reservation table or the slot table.

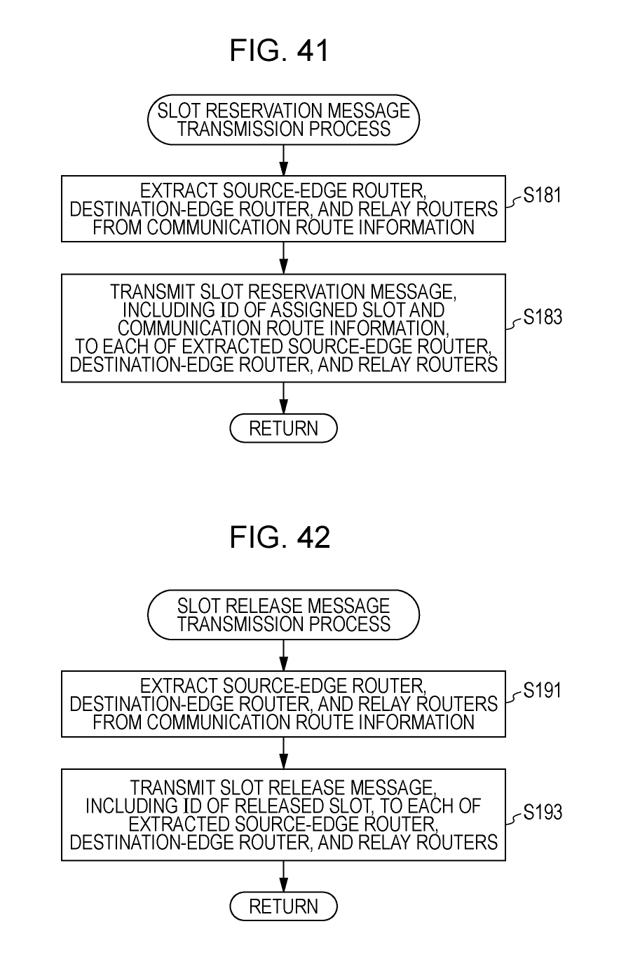

A processing flow in the management server 5 in the second embodiment will be described below. The processing flow in the management server 5 is basically the same as that described above in connection with the first embodiment except for the following points. In the second embodiment, processing illustrated in FIG. 41 (i.e., a slot reservation message transmission process) is executed instead of the processing of step S25. Further, processing illustrated in FIG. 42 (i.e., a slot release message transmission process) is executed instead of the processing of step S45. In addition, it is assumed in the second embodiment that, after the processing of step S23, the slot reservation processing section 505 notifies the ID of the assigned slot and the communication route information to the slot reservation message transmitting section 519. It is also assumed that, after the processing of step S43, the slot release processing section 507 notifies the ID of the released slot to the slot release message transmitting section 521. Those processes will be described below.

First, the slot reservation message transmission process is described with reference to FIG. 41. The slot reservation message transmission process is executed by the slot reservation message transmitting section 519. Upon receiving the ID of the assigned slot and the communication route information from the slot reservation processing section 505, the slot reservation message transmitting section 519 extracts the source-edge router, the destination-edge router, and one or more relay routers 3 from the communication route information (FIG. 41: step S181). Herein, one or more relay routers 3 through which the packet passes until reaching the destination-edge router are extracted. Further, the slot reservation message transmitting section 519 transmits the slot reservation message, including the ID of the assigned slot and the communication route information, to each of the extracted source-edge router, destination-edge router, and relay routers 3 (step S183). The slot reservation message transmission process is then brought to an end, followed by returning to the main processing flow.

The slot release message transmission process will be described below with reference to FIG. 42. The slot release message transmission process is executed by the slot release message transmitting section 521. Upon receiving the ID of the released slot from the slot release processing section 507, the slot release message transmitting section 521 extracts the source-edge router, the destination-edge router, and one or more relay routers 3 from the communication route information (FIG. 42: step S191). Herein, one or more relay routers 3 through which the packet passes until reaching the destination-edge router are extracted. Further, the slot release message transmitting section 521 transmits the slot release message, including the ID of the released slot, to each of the extracted source-edge router, destination-edge router, and relay routers 3 (step S193). The slot release message transmission process is then brought to an end, followed by returning to the main processing flow.

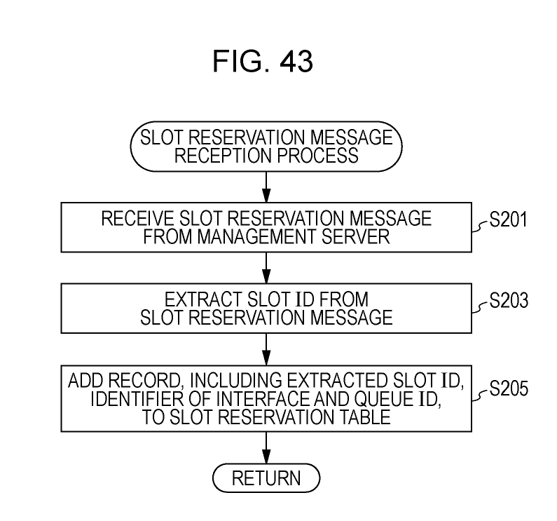

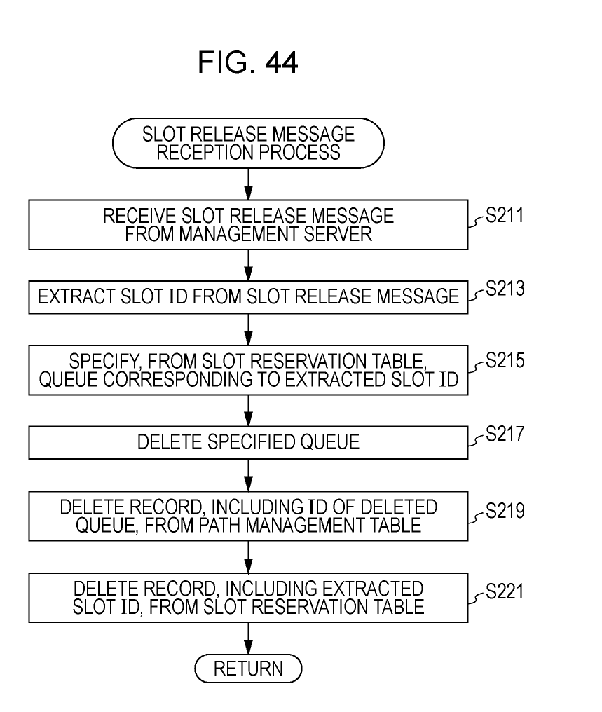

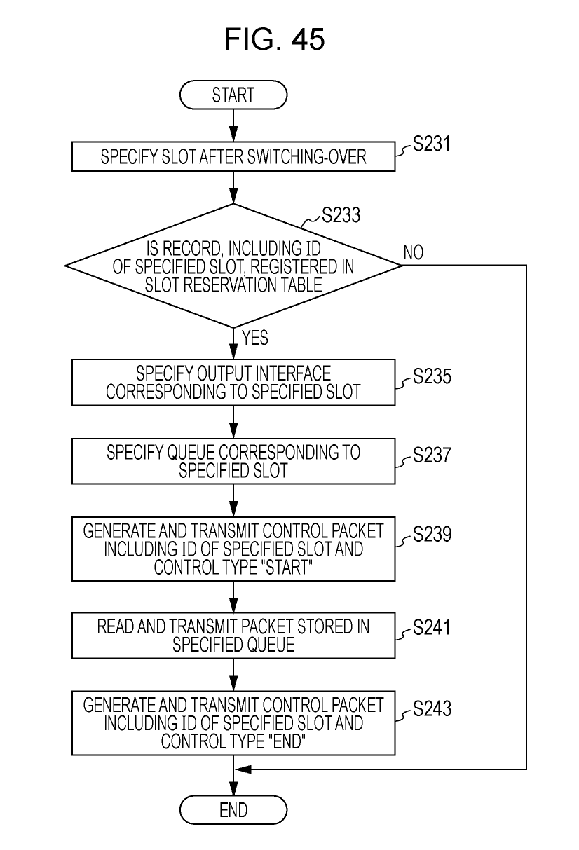

A processing flow in the edge router 1 in the second embodiment will be described below. The processing flow in the edge router 1 is basically the same as that described above in connection with the first embodiment except for the following points. In the second embodiment, processing illustrated in FIG. 43 (i.e., a slot reservation message reception process) is executed instead of the processing of steps S75 and S77. Further, processing illustrated in FIG. 44 (i.e., a slot release message reception process) is executed instead of the processing of steps S129 to S135. In addition, processing illustrated in FIG. 45 is executed instead of the processing illustrated in FIG. 31. Those processes will be described below.

First, the slot reservation message reception process will be described with reference to FIG. 43. The slot reservation message reception process is executed by the slot reserving section 111. The slot reserving section 111 receives the slot reservation message from the management server 5 and stores the received slot reservation message in the storage device (FIG. 43: step S201). Further, the slot reserving section 111 extracts the slot ID from the slot reservation message (step S203). In accordance with the communication route information, the slot reserving section 111 specifies an interface from the edge router table and specifies a queue ID from the path management table. Still further, the slot reserving section 111 generates a record including the extracted slot ID, the identifier of the specified interface and the specified queue ID, and then adds the generated record to the slot reservation table (step S205). The slot reservation message reception process is then brought to an end, followed by returning to the main processing flow.

Next, the slot release message reception process will be described below with reference to FIG. 44. The slot release message reception process is executed by the slot releasing section 117. The slot releasing section 117 receives the slot release message from the management server 5 and stores the received slot release message in the storage device (FIG. 44: step S221). Further, the slot releasing section 117 extracts the slot ID from the slot release message (step S213). From the slot reservation table, the slot releasing section 117 specifies the queue 1071 corresponding to the extracted slot ID (step S215). Still further, the slot releasing section 117 outputs an instruction indicating deletion of the specified queue 1071 to the packet classifying section 107. The packet classifying section 107 deletes the specified queue 1071 in response to the instruction from the slot releasing section 117 (step S217).

Then, the slot releasing section 117 deletes the record, including the ID of the deleted queue, from the path management table (step S219). Further, the slot releasing section 117 deletes the record, including the extracted slot ID, from the slot reservation table (step S221). The slot release message reception process is then brought to an end, followed by returning to the main processing flow.

A processing flow in the edge router 1 when the time slot is switched over will be described below with reference to FIG. 45. When switching-over of the time slot is detected, the scheduling section 115 specifies a slot after the switching-over (FIG. 45: step S231).

Then, the scheduling section 115 determines whether the record including the ID of the specified slot is registered in the slot reservation table (step S233). If it is determined that the record including the ID of the specified slot is not registered in the slot reservation table (step S233: No route), the processing of FIG. 45 is brought to an end.

On the other hand, it is determined that the record including the ID of the specified slot is registered in the slot reservation table (step S233: Yes route), the scheduling section 115 specifies an output interface corresponding to the specified slot from the slot reservation table (step S235). Further, the scheduling section 115 specifies a queue 1071 corresponding to the specified slot from the slot reservation table (step S237). The scheduling section 115 generates a control packet including the ID of the specified slot and the control type “start” and transmits the generated control packet to the destination-edge router through the specified output interface (step S239). The scheduling section 115 successively reads data packets from the specified queue 107 and transmits those data packets to the destination-edge router through the specified output interface (step S241). Still further, the scheduling section 115 generates a control packet including the ID of the specified slot and the control type “end” and transmits the generated control packet to the destination-edge router through the specified output interface (step S243). The processing of FIG. 45 is then brought to an end.

A processing flow in the relay router 3 in the second embodiment will be described below. The processing flow in the relay router 3 is basically the same as that described above in connection with the first embodiment except for the following points. Because the control packets (control type: “reservation” and “release”) are not used in the second embodiment, the forwarding engine 307 skips the processing of steps S147 and shifts to step 151 after the processing of step S145. In addition, if it is determined in step S159 that the control type is not “end” (step S159: No route), the processing is brought to an end. Accordingly, the second embodiment is not required to execute the processing of steps S149, S150, S165 and S167.

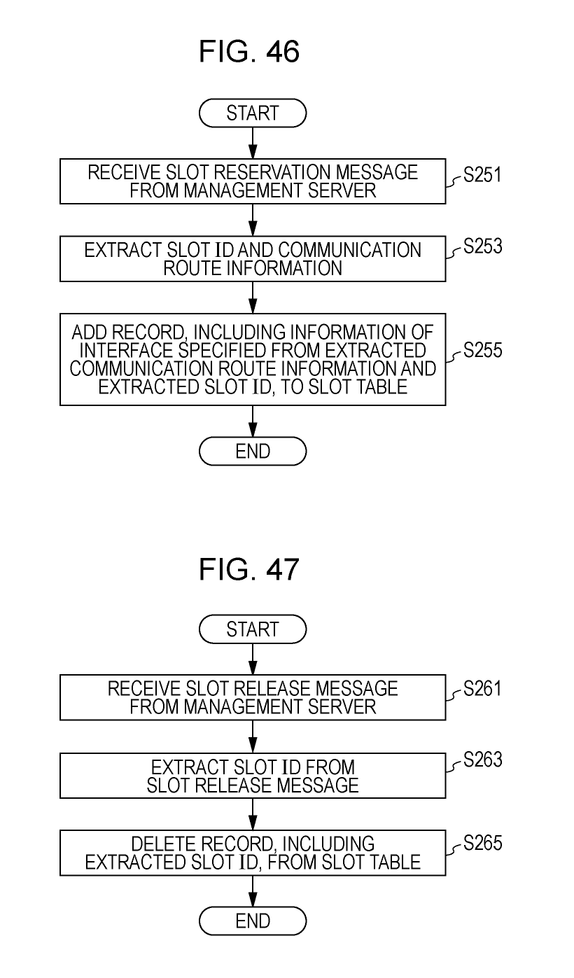

Further, in the second embodiment, the relay router 3 executes processing, illustrated in FIG. 46, upon receiving the slot reservation message and executes processing, illustrated in FIG. 47, upon receiving the slot release message. Those processes will be described below.

First, a processing flow when the slot reservation message is received will be described with reference to FIG. 46. The forwarding engine 307 receives the slot reservation message from the management server 5 and stores the received slot reservation message in the storage device (FIG. 46: step S251). Further, the forwarding engine 307 extracts the slot ID and the communication route information from the slot reservation message (step S253). Still further, the forwarding engine 307 generates a record including both information of an interface, which is specified based on the extracted communication route information, and the extracted slot ID, and then adds the generated record to the slot table (step S255). The processing of FIG. 46 is then brought to an end.

A processing flow when the slot release message is received will be described below with reference to FIG. 47. The forwarding engine 307 receives the slot release message from the management server 5 and stores the received slot release message in the storage device (FIG. 47: step S261). Further, the forwarding engine 307 extracts the slot ID from the slot release message (step S263). Still further, the forwarding engine 307 deletes the record including the extracted slot ID from the slot table (step S265). The processing of FIG. 47 is then brought to an end.

With the processing executed as described above, even when the time slot is reserved and released by using the slot reservation message and the slot release message, power saving in the relay router 3 can be achieved similarly to the first embodiment.

### Third Embodiment

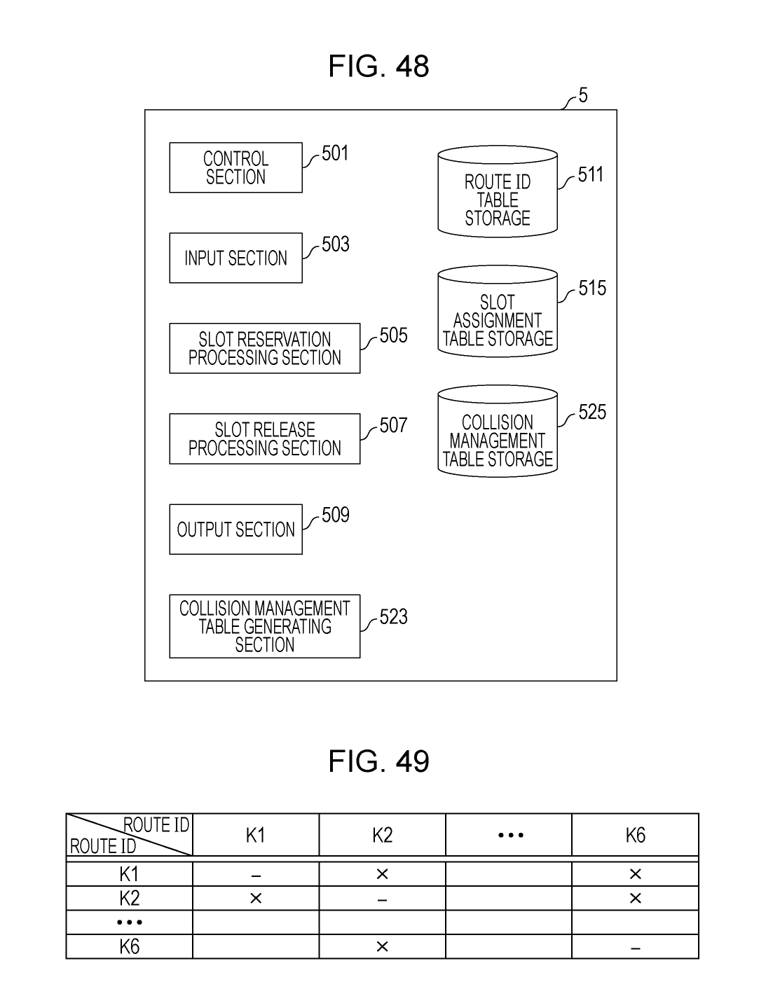

A third embodiment of the present technique will be described below with reference to FIGS. 48 to 53. In the first and second embodiments described above, the time slot to be assigned is determined by the management server 5 based on the link use situation table. In the third embodiment, however, the time slot to be assigned is determined based on a collision management table that stores collision relationships among the communication routes.

FIG. 48 is a functional block diagram of the management server 5 in the third embodiment. The management server 5 in the third embodiment includes a control section 501, an input section 503, a slot reservation processing section 505, a slot release processing section 507, an output section 509, a collision management table generating section 523, a route ID table storage 511, a slot assignment table storage 515, and a collision management table storage 525. The control section 501, the input section 503, the slot reservation processing section 505, the slot release processing section 507, the output section 509, the route ID table storage 511, and the slot assignment table storage 515 are basically the same as those in the first embodiment.

Respective functional block diagrams of the edge router 1 and the relay router 3 are basically the same as those illustrated in FIGS. 8 and 9.

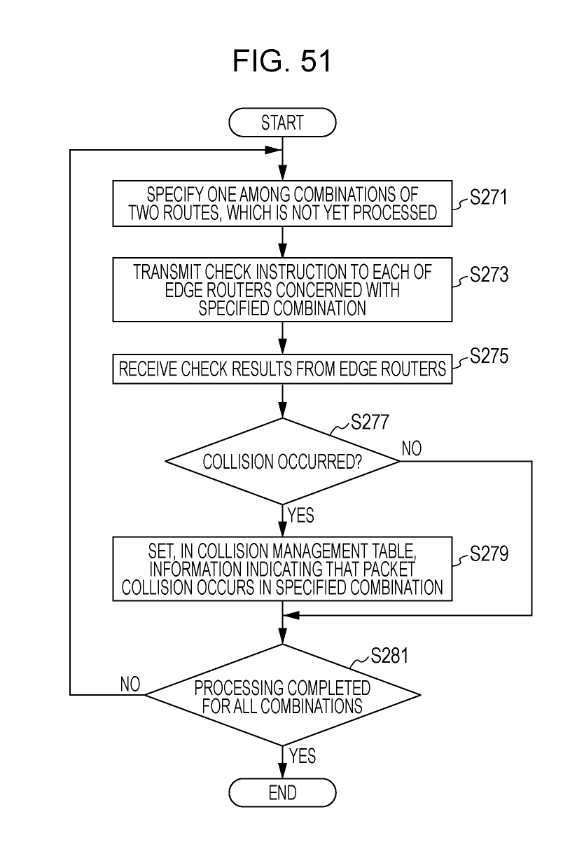

The collision management table storage 525 stores a collision management table described later. The collision management table generating section 523 executes processing illustrated in FIG. 51 and generates the collision management table. The processing illustrated in FIG. 51 will be described later.

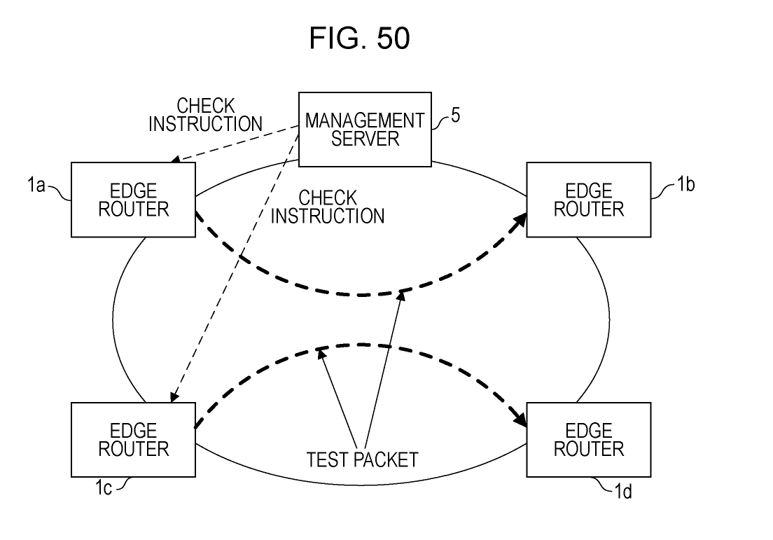

FIG. 49 illustrates an example of the collision management table stored in the collision management table storage 525. In the example of FIG. 49, columns and rows of the collision management table are divided per route ID. Stated another way, the collision management table sets, per combination of the route IDs, whether a packet collision occurs or not in each combination (“x”: indicating occurrence of a packet collision, and blank: indicating no packet collision). Be it noted that the collision management table is set based on check results, for example, which are obtained by performing packet collision checks illustrated in FIG. 50. Whether test packets collide with each other is checked by transmitting the test packets so as to simultaneously flow through two routes (e.g., the route between the edge routers 1a and 1b and the between the edge routers 1c and 1d in FIG. 50). More specifically, whether a packet collision has occurred is determined by the following determination method. For example, when the relay router 3 is held stand-by to start transmission in the event of a packet collision, no packet collision is determined if the test packet reaches the destination-edge router in the same time slot as that used for the transmission. Also, when the relay router 3 discards the packet in the event of a packet collision, no packet collision is determined if the test packet reaches the destination-edge route. Further, when the relay router 3 outputs a collision signal to the destination-edge router in the event of a packet collision, no packet collision is determined if the collision signal is not detected by the destination-edge router. Any of other suitable determination methods can also be used. The collision management table can be generated by performing such a check per combination of the routes.

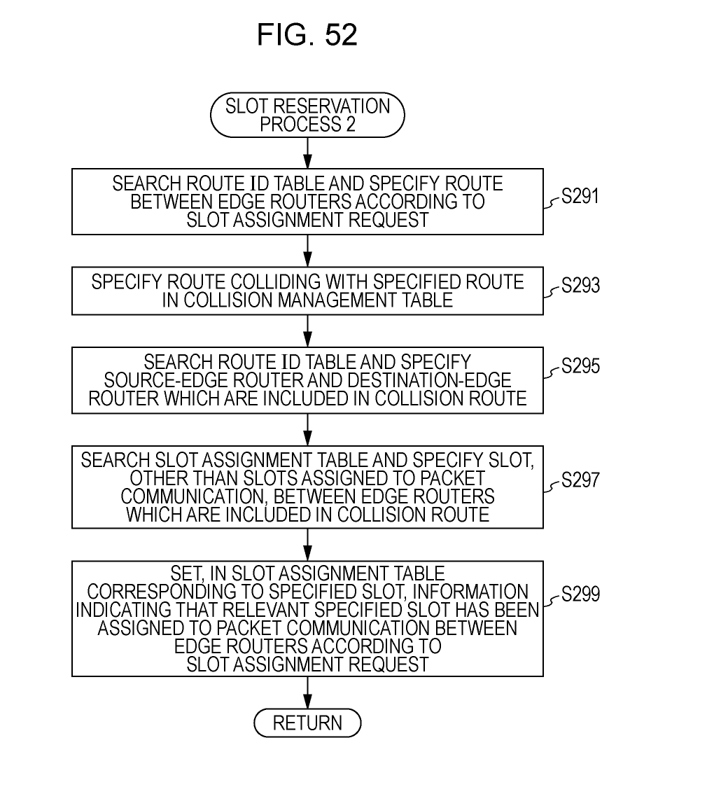

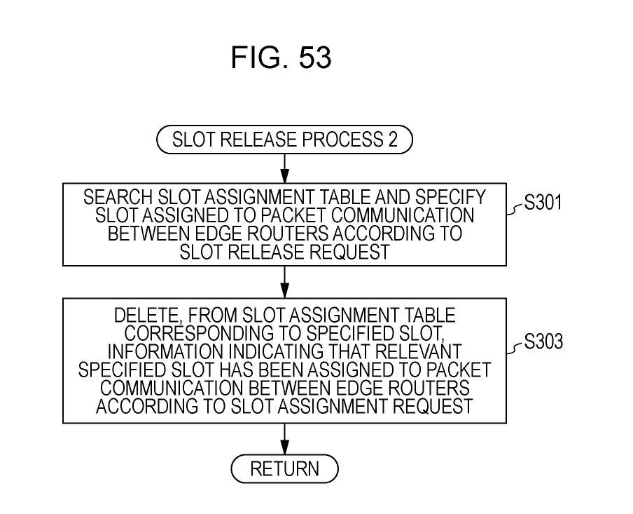

A processing flow in the management server 5 in the third embodiment will be described below with reference to FIGS. 51 to 53. The processing flow in the management server 5 is basically the same as that described above in connection with the first embodiment except for the following points. In the third embodiment, processing illustrated in FIG. 51 is executed to generate the collision management table. Further, in the third embodiment, processing illustrated in FIG. 52 (i.e., a slot reservation process 2) is executed instead of the processing of step S23. In addition, processing illustrated in FIG. 53 (i.e., a slot release process 2) is executed instead of the processing of step S43. Those processes will be described below.

First, a process of generating the collision management table will be described with reference to FIG. 51. The processing illustrated in FIG. 51 is executed by the collision management table generating section 523 of the management server 5 at an arbitrary timing. In accordance with the information regarding the network configuration, the collision management table generating section 523 specifies one among the combinations of two routes, which is not yet processed (FIG. 51: step S271). Further, the collision management table generating section 523 transmits a check instruction to each of the edge routers which are concerned with the specified combination (step S273). The check instruction contains information regarding the transmission timing of test packets, the source-edge router, the destination-edge router, etc. The edge router 1 having received the check instruction performs the check, illustrated in FIG. 50, in accordance with the check instruction.

Thereafter, the collision management table generating section 523 receives the check result from each edge router 1 (step S275) and determines whether a collision of the test packets has occurred (step S277). If it is determined that a collision of the test packets has occurred (step S277: Yes route), the collision management table generating section 523 sets, in the collision management table, the information (“x” in FIG. 49) indicating that a packet collision occurs in the specified combination (step S27). Thereafter, the collision management table generating section 523 shifts to processing of step S281.

On the other hand, if it is determined that a collision of the test packets has not occurred (step S277: No route), the collision management table generating section 523 skips the processing of step S279 and shifts to the processing of step S281.

Then, the collision management table generating section 523 determines whether the processing is completed for all the combinations (step S281). If it is determined that the processing is not yet completed for all the combinations (step S281: No route), the collision management table generating section 523 returns to the processing of step S271 and repeats the processing of steps S271 to S281. On the other hand, if it is determined that the processing is completed for all the combinations (step S281: Yes route), the processing of FIG. 51 is brought to an end.

The slot reservation process 2 will be described below with reference to FIG. 52. First, the slot reservation processing section 505 searches the route ID table based on the respective identifiers of the source-edge router and the destination-edge router, which are included in the slot assignment request, and specifies the route between the edge routers according to the slot assignment request (FIG. 52: step S291).

Then, the slot reservation processing section 505 specifies, in the collision management table, a route (hereinafter referred to as a “collision route”) causing a collision with the specified route (step S293). Further, the slot reservation processing section 505 searches the route ID table and specifies a source-edge router and a destination-edge router included in the collision route (step S295).

Then, the slot reservation processing section 505 searches the slot assignment table and specifies a slot other than the slot that is assigned to the packet communication between the edge routers included in the collision route (step S297). Further, the slot reservation processing section 505 sets, in the slot assignment table corresponding to the specified slot, information indicating that the relevant specified slot has been assigned to the packet communication between the edge routers according to the slot assignment request (step S299). The slot reservation process 2 is then brought to an end, followed by returning to the main processing flow.

The slot release process 2 will be described below with reference to FIG. 53. First, the slot release processing section 507 searches the slot assignment table based on the respective identifiers of the source-edge router and the destination-edge router, which are included in the slot release request, and specifies a slot assigned to the packet communication between the edge routers according to the slot release request (FIG. 53: step S301). Further, the slot release processing section 507 deletes, from the slot assignment table corresponding to the specified slot, information (“◯” in FIG. 17) indicating that the relevant specified slot has been assigned to the packet communication between the edge routers according to the slot release request (step S303). The slot release process 2 is then brought to an end, followed by returning to the main processing flow.

With the processing executed as described above, even when the collision management table is used, power saving in the relay router 3 can be achieved similarly to the first embodiment.

While the embodiments of the present technique have been described above, the present technique is not limited to those embodiments. For example, the above-described functional block diagrams of the edge router 1, the relay router 3, and the management server 5 does not always correspond to an actual program module configuration.

Also, the configuration of each of the above-described tables is illustrated merely by way of example and is not always limited to the above-described example. Further, in the processing flow, the sequence of steps can be changed or replaced unless the processing result remains the same. As an alternative, the steps may be executed in parallel.

In the above-described embodiments, for example, the packet communication from the edge router 1a to the edge router 1d and the packet communication from the edge router 1d to the edge router 1a are not discriminated from each other, and both the packet communications are managed by using one route ID. However, those packet communications may be managed by using different route IDs. In such a case, separate time slots are assigned respectively to those packet communications.

The above-described embodiments of the present technique can be summarized as follows.

According to a first aspect, in a network apparatus for relaying a packet communicated between edge routers in a network, the network apparatus comprises a slot table for storing a record including an identifier of a time slot witch is assigned to packet transmission from a particular transmission source to a particular transmission destination, and respective identifiers of an input interface and an output interface which are used for the packet transmission; and means for, upon receiving a first control packet which includes an identifier of a particular time slot and indicates a start of the particular time slot, specifying the input interface and the output interface corresponding to the particular time slot from the slot table, and for sending out one or more packets from the specified input interface to the specified output interface during a period until receiving a second control packet which includes the identifier of the particular time slot and indicates an end of the particular time slot.

With such a configuration, the packets to be communicated between the edge routers can be properly relayed during the period from the reception of the first control packet to the reception of the second control packet without executing the routing process. Also, since a packet collision can be avoided, for example, by properly assigning the time slot, the network apparatus is not required to execute the packet buffering process. In other words, power consumed by the packet buffering process and the routing process can be cut and hence power saving can be achieved in the network apparatus.

Further, the network apparatus may further comprise means for, when a slot reservation instruction including the identifier of the particular time slot and information of a communication route is received, storing in the slot table the record including the identifier of the particular time slot, which is included in the slot reservation instruction, and the respective identifiers of the input interface and the output interface, which are specified from the information of the communication route included in the slot reservation instruction. Such a configuration enables a proper action to be taken when a new time slot is assigned.

In addition, the network apparatus may further comprise means for, when a slot release instruction including the identifier of the particular time slot is received, deleting the record including the identifier of the particular time slot, which is included in the slot release instruction, from the slot table. Such a configuration enables a proper action to be taken when any assignment has become no longer needed.

An edge router according to a second aspect comprises an edge router table for storing a transmission destination address of one or more packets and an identifier of a destination-edge router corresponding to the transmission destination address; a queue per destination-edge router; a slot reservation table for storing a record including an identifier of a time slot witch is assigned to packet transmission destined for a particular destination-edge router, an identifier of an output interface which is used for the packet transmission, and an identifier of the queue corresponding to the particular destination-edge router; packet receiving means for receiving the packets from an external network; packet classifying means for specifying, from the edge router table, the destination-edge router corresponding to the transmission destination address of the received packets, and for storing the received packets in the queue corresponding to the specified destination-edge router; and scheduling means for, when switching-over to a particular time slot is detected, specifying the output interface and the queue, which correspond to the particular time slot, from the slot reservation table, transmitting a first control packet, which includes an identifier of the particular time slot and indicates a start of the particular time slot, through the specified output interface, successively transmitting the packets read out from the specified queue after transmitting the first control packet, and for transmitting, as a final packet in the particular time slot, a second control packet which includes the identifier of the particular time slot and indicates an end of the particular time slot.

With such a configuration, since some time slot is used only for the packet communication assigned to the relevant time slot, the communication between the edge routers can be performed without causing a packet collision by, for example, properly assigning each time slot. Also, the timings of start and end of the time slot can be notified to, for example, the network apparatus (e.g., the router) on the communication route up to the destination-edge router by transmitting the first control packet and the second control packet. In other words, the network apparatus is no longer required to establish synchronization of the time slot.

Further, the edge router may further comprise means for determining whether the time slot is assigned to the packet communication destined for the destination-edge router which has been specified by the packet classifying means, and for transmitting a slot assignment request to a management server, which manages the time slot, when the time slot is not assigned to the aforesaid packet communication; and slot reservation means for, when a slot assignment notice including the identifier of the time slot and information of a communication route is received from the management server, registering in the slot reservation table a record including the identifier of the time slot, which is included in the slot assignment notice, the identifier of the output interface specified based on the information of the communication route, which is included in the slot assignment notice, and the identifier of the queue corresponding to the particular destination-edge router which has been specified by the packet classifying means. Further, the scheduling means may include means for, when a new time slot is assigned, transmitting a third control packet which includes an identifier of the new time slot and represents reservation of the new time slot. Such a configuration enables a proper action to be taken when there generates new packet communication to which the time slot is not assigned.

Still further, the edge router may further comprise means for transmitting a slot release request to the management server when, during a period until the end of a certain time after storing the packet into the queue, a next packet to be stored in the queue is not received, and means for, when a slot release completion notice including an identifier of the released time slot is received from the management server, deleting the record including the identifier of the time slot, which is included in the slot release completion notice, from the slot reservation table. In addition, the scheduling means may include means for, when any of the time slots is released, transmitting a fourth control packet which includes an identifier of the released time slot and represents the release of the relevant time slot. With such a configuration, when a packet is not received for a certain time or longer, the assigned time slot is released such that the relevant time slot can be reassigned to another packet communication. In other words, a limited number of time slots can be more effectively utilized.

A packet communication system according to a third aspect comprises edge routers each performing packet communication while a time slot is synchronized by using definition information and sync time information of the time slot; a network apparatus for relaying one or more packets communicated between the edge routers; and a management server for delivering the definition information and the sync time information of the time slot to each of the edge routers. Each of the edge routers comprises an edge router table for storing a transmission destination address of the packets and an identifier of a destination-edge router corresponding to the transmission destination address; a queue per destination-edge router; a slot reservation table for storing an identifier of a time slot witch is assigned to packet transmission destined for a particular destination-edge router, an identifier of a first output interface which is used for the packet transmission, and an identifier of the queue corresponding to the particular destination-edge router; means for receiving the packets from an external network; means for specifying, from the edge router table, the destination-edge router corresponding to the transmission destination address of the received packets, and for storing the received packets in the queue corresponding to the specified destination-edge router; and means for, when switching-over to a particular time slot is detected in a sequential flow of time slots, which is determined based on definition information of each time slot, specifying the first output interface and the queue, which correspond to the particular time slot, from the slot reservation table, transmitting a first control packet, which includes an identifier of the particular time slot and indicates a start of the particular time slot, through the specified first output interface, successively transmitting the packets read out from the specified queue after transmitting the first control packet, and for transmitting, as a final packet in the particular time slot, a second control packet which includes the identifier of the particular time slot and indicates an end of the particular time slot. The network apparatus comprises a slot table for storing an identifier of the particular time slot and respective identifiers of an input interface and a second output interface which are used for the packet transmission in the particular time slot; and means for, when the first control packet is received, specifying from the slot table the input interface and the second output interface corresponding to the identifier of the particular time slot, which is included in the first control packet, and for sending out the packets from the specified input interface to the specified output interface during a period until the second control packet is received.

Additionally, a program can be prepared to realize the edge router 1, the relay router 3, and the management server 5 in cooperation with hardware. The program is stored in a storage medium or a storage device, such as a flexible disk, a CD-ROM, a magneto-optical disk, a semiconductor memory, or a hard disk. Further, intermediate processing results are temporarily stored in a storage device, e.g., a main memory.

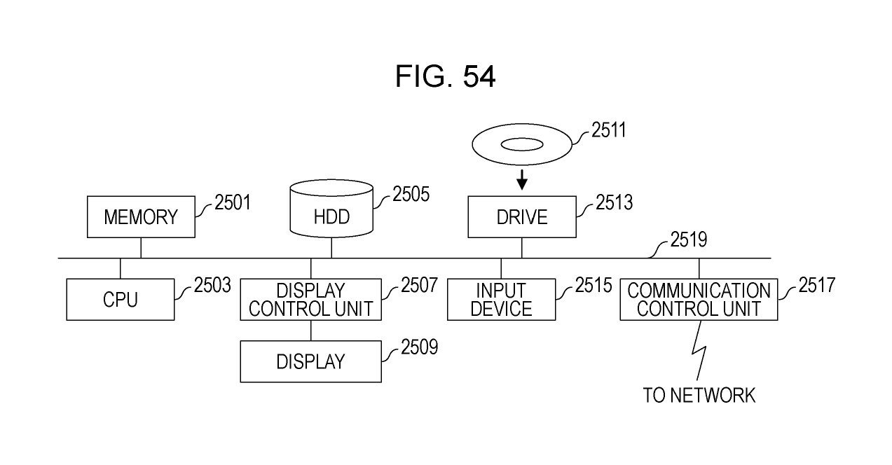

In the management server 5, as illustrated in FIG. 54, a memory 2501 (storage), a CPU 2503 (processing unit), a hard disk drive (HDD) 2505, a display control unit 2507 connected to a display 2509, a drive 2513 for a removable disk 2511, an input device 2515, and a communication control unit 2517 for connection to a network are interconnected via a bus 2519. Application programs, including an OS and a Web browser, are stored in the HDD 250 and are read out from the HDD 250 into the memory 2501 when each program is executed by the CPU 2503. The CPU 2503 controls the display control unit 2507, the communication control unit 2517, and the drive 2513, as required, such that they perform necessary operations. Data generated during the processing is stored in the memory 2501 and is saved into the HDD 2505, if necessary. A computer illustrated in FIG. 54 realizes the above-described various functions with organic cooperation of the hardware such as the memory 2501, the OS, and the required application programs.

The embodiment described above is a preferred embodiment. The present invention is not limited to this but various modifications can be made without departing from the spirit of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions has been described in detail, it should be understood that the various changes, substitutions, and alterations could be made hereto without departing from the spirit and scope of the invention.

What is claimed is:

1. A network apparatus for relaying a packet communicated between edge routers in a network, the network apparatus comprising:
a slot table for storing a record including an identifier of a time slot witch is assigned to packet transmission from a particular transmission source to a particular transmission destination, and respective identifiers of an input interface and an output interface which are used for the packet transmission; and
means for, upon receiving a first control packet which includes an identifier of a particular time slot and indicates a start of the particular time slot, specifying the input interface and the output interface corresponding to the particular time slot from the slot table, and for sending out one or more packets from the specified input interface to the specified output interface during a period until receiving a second control packet which includes the identifier of the particular time slot and indicates an end of the particular time slot.

2. An edge router comprising:
an edge router table for storing a transmission destination address of one or more packets and an identifier of a destination-edge router corresponding to the transmission destination address;
a queue per destination-edge router;
a slot reservation table for storing a record including an identifier of a time slot witch is assigned to packet transmission destined for a particular destination-edge router, an identifier of an output interface which is used for the packet transmission, and an identifier of the queue corresponding to the particular destination-edge router;
packet receiving means for receiving the packets from an external network;
packet classifying means for specifying, from the edge router table, the destination-edge router corresponding to the transmission destination address of the received packets, and for storing the received packets in the queue corresponding to the specified destination-edge router; and
scheduling means for, when switching-over to a particular time slot is detected, specifying the output interface and the queue, which correspond to the particular time slot, from the slot reservation table, transmitting a first control packet, which includes an identifier of the particular time slot and indicates a start of the particular time slot, through the specified output interface, successively transmitting the packets read out from the specified queue after transmitting the first control packet, and for transmitting, as a final packet in the particular time slot, a second control packet which includes the identifier of the particular time slot and indicates an end of the particular time slot.

3. A packet communication system comprising:
edge routers each performing packet communication while a time slot is synchronized by using definition information and sync time information of the time slot;
a network apparatus for relaying one or more packets communicated between the edge routers; and
a management server for delivering the definition information and the sync time information of the time slot to each of the edge routers,
each of the edge routers comprising:
an edge router table for storing a transmission destination address of the packets and an identifier of a destination-edge router corresponding to the transmission destination address;
a queue per destination-edge router;
a slot reservation table for storing an identifier of a time slot witch is assigned to packet transmission destined for a particular destination-edge router, an identifier of a first output interface which is used for the packet transmission, and an identifier of the queue corresponding to the particular destination-edge router;
means for receiving the packets from an external network;
means for specifying, from the edge router table, the destination-edge router corresponding to the transmission destination address of the received packets, and for storing the received packets in the queue corresponding to the specified destination-edge router; and
means for, when switching-over to a particular time slot is detected in a sequential flow of time slots, which is determined based on definition information of each time slot, specifying the first output interface and the queue, which correspond to the particular time slot, from the slot reservation table, transmitting a first control packet, which includes an identifier of the particular time slot and indicates a start of the particular time slot, through the specified first output interface, successively transmitting the packets read out from the specified queue after transmitting the first control packet, and for transmitting, as a final packet in the particular time slot, a second control packet which includes the identifier of the particular time slot and indicates an end of the particular time slot,
the network apparatus comprising:
a slot table for storing an identifier of the particular time slot and respective identifiers of an input interface and a second output interface which are used for the packet transmission in the particular time slot; and
means for, when the first control packet is received, specifying from the slot table the input interface and the second output interface corresponding to the identifier of the particular time slot, which is included in the first control packet, and for sending out the packets from the specified input interface to the specified output interface during a period until the second control packet is received.

4. The network apparatus according to claim 1, further comprising:
means for, when a slot reservation instruction including the identifier of the particular time slot and information of a communication route is received, storing in the slot table the record including the identifier of the particular time slot, which is included in the slot reservation instruction, and the respective identifiers of the input interface and the output interface, which are specified from the information of the communication route included in the slot reservation instruction.

5. The network apparatus according to claim 1, further comprising:
means for, when a slot release instruction including the identifier of the particular time slot is received, deleting the record including the identifier of the particular time slot, which is included in the slot release instruction, from the slot table.

6. The edge router according to claim 2, further comprising:
means for determining whether the time slot is assigned to the packet communication destined for the destination-edge router which has been specified by the packet classifying means, and for transmitting a slot assignment request to a management server, which manages the time slot, when the time slot is not assigned to the aforesaid packet communication; and
slot reservation means for, when a slot assignment notice including the identifier of the time slot and information of a communication route is received from the management server, registering in the slot reservation table a record including the identifier of the time slot, which is included in the slot assignment notice, the identifier of the output interface specified based on the information of the communication route, which is included in the slot assignment notice, and the identifier of the queue corresponding to the particular destination-edge router which has been specified by the packet classifying means.

7. The edge router according to claim 6, wherein the scheduling means includes means for, when a new time slot is assigned, transmitting a third control packet which includes an identifier of the new time slot and represents reservation of the new time slot.

8. The edge router according to claim 2, further comprising:
means for transmitting a slot release request to the management server when, during a period until the end of a certain time after storing the packet into the queue, a next packet to be stored in the queue is not received, and
means for, when a slot release completion notice including an identifier of the released time slot is received from the management server, deleting the record including the identifier of the time slot, which is included in the slot release completion notice, from the slot reservation table.

9. The edge router according to claim 8, wherein the scheduling means includes means for, when any of the time slots is released, transmitting a fourth control packet which includes an identifier of the released time slot and represents the release of the relevant time slot.
